(19) United States
(12) Patent Application Publication
(10) Pub. No.: US 2025/0168260 A1
(43) Pub. Date: May 22, 2025

(54) METHODS AND APPARATUS FOR DIFFERENTIAL QUALITY OF SERVICE (QOS) HANDLING OF PACKETS WITHIN A SAME SERVICE STREAM

(71) Applicant: Huawei Technologies Co., Ltd., Shenzhen (CN)

(72) Inventor: Yunsong Yang, San Diego, CA (US)

(21) Appl. No.: 19/028,981

(22) Filed: Jan. 17, 2025

Related U.S. Application Data
(63) Continuation of application No. PCT/US2023/029589, filed on Aug. 7, 2023.
(60) Provisional application No. 63/501,290, filed on May 10, 2023.
(60) Provisional application No. 63/396,489, filed on Aug. 9, 2022.

(51) Int. Cl. H04L 69/22; H04L 47/34; H04W 28/02; H04W 80/02

(52) U.S. Cl. CPC H04L 69/22; H04L 47/34; H04W 28/0268; H04W 80/02

(57) ABSTRACT

According to embodiments, the first PDCP entity receives a PDCP DU from an associated upper layer. The first PDCP entity processes the PDCP SDU with the COUNT value to produce a first PDCP data PDU. The first PDCP entity determines a need to abandon transmission of the first PDCP data PDU. The first PDCP entity discards the first PDCP data PDU. The first PDCP entity notifies a second PDCP entity of a second device about COUNT information related to one or more discarded COUNT values. The one or more discarded COUNT values are associated with one or more discarded PDCP data PDUs. The one or more discarded PDCP data PDUs include the first PDCP data PDU. The second PDCP entity is a peer PDCP entity of the first PDCP entity for processing data received from the first device.

### CROSS-REFERENCE TO RELATED APPLICATION

This application is a continuation of International Application No. PCT/US2023/029589 filed on Aug. 7, 2023 and entitled “Methods and Apparatus for Differential Quality of Service (QOS) Handling of Packets within A Same Service Stream,” which claims the benefit of U.S. Provisional Patent Application No. 63/396,489, filed on Aug. 9, 2022 and entitled “Methods and Apparatus for Differential Quality of Service (QOS) Handling of Packets within A Same Service Stream,” and U.S. Provisional Patent Application No. 63/501,290, filed on May 10, 2023 and entitled “Methods and Apparatus for Differential Quality of Service (QOS) Handling of Packets within A Same Service Stream,” applications of which are incorporated herein by reference.

### TECHNICAL FIELD

The present disclosure relates generally to methods and apparatus for network communications, and, in particular embodiments, to methods and apparatus for differential QoS handling of packets.

### BACKGROUND

As a sublayer of the Layer 2 protocol in 5G new radio (NR), the packet data convergence protocol (PDCP) provides various functions, such as transfer of data for the user plane and the control plane, maintenance of PDCP sequence numbers (SNs), header compression and decompression, ciphering and deciphering, integrity protection and integrity verification, packet routing (for split bearers and the dual active protocol stacks (DAPS) bearer), packet duplication (for PDCP duplication), duplicate detection and discarding, packet reordering, and in-order delivery, timer based service data unit (SDU) discarding, etc.

### SUMMARY

Technical advantages are generally achieved, by embodiments of this disclosure which describe methods and apparatus for differential QoS handling of packets.

According to embodiments, the first PDCP entity receives a PDCP service data unit (SDU) from an associated upper layer of the first PDCP entity. The first PDCP entity associates a COUNT value with the PDCP SDU. The first PDCP entity processes the PDCP SDU with the COUNT value to produce a first PDCP data protocol data unit (PDU). The first PDCP entity determines a need to abandon transmission of the first PDCP data PDU. The first PDCP entity discards the first PDCP data PDU based on the determining the need to abandon the transmission of the first PDCP data PDU. The first PDCP entity notifies a second PDCP entity of a second device about COUNT information related to one or more discarded COUNT values. The one or more discarded COUNT values are associated with one or more discarded PDCP data PDUs. The one or more discarded PDCP data PDUs include the first PDCP data PDU. The second PDCP entity is a peer PDCP entity of the first PDCP entity for processing data received from the first device.

In some embodiments, the COUNT information may indicate a first discarded COUNT (FDC) value. The FDC value may be a smallest COUNT value among the one or more discarded COUNT values.

In some embodiments, the COUNT information may further include a bitmap indicating additionally discarded COUNT values. The one or more discarded COUNT values may include the FDC value and the additionally discarded COUNT values. Each bit in the bitmap may correspond to a unique COUNT value among a sequence of contiguous COUNT values. The sequence of contiguous COUNT values may immediately follow the FDC value numerically and comprise the additionally discarded COUNT values. The each bit in the bitmap may carry either a first value indicating that a corresponding COUNT value is associated with a discarded PDCP data PDU or a second value indicating that the corresponding COUNT value is unassociated with any of the discarded PDCP data PDUs.

In some embodiments, the COUNT information may further indicate a total number of additionally discarded COUNT values. The one or more discarded COUNT values may include the FDC value and a number of contiguous COUNT values immediately following the FDC value numerically. The number may be equal to the total number.

In some embodiments, the COUNT information may indicate a last discarded COUNT (LDC) value. The LDC value may be a largest COUNT value among the one or more discarded COUNT values.

In some embodiments, the first PDCP entity may notify the second PDCP entity about the COUNT information by indicating that any COUNT values smaller than the LDC value and having not been received yet, upon being notified, are to be considered as among the one or more discarded COUNT values.

In some embodiments, the COUNT information may indicate a first resumed COUNT (FRC) value. The FRC value may be associated with a second PDCP data PDU. The second PDCP data PDU may be an earliest PDCP PDU to be transmitted to the second PDCP entity when the transmission to the second PDCP entity is resumed. The FRC value may be a smallest COUNT value used after the transmission to the second PDCP entity is resumed and greater than any of the one or more discarded COUNT values.

In some embodiments, the first PDCP entity may notify the second PDCP entity about the COUNT information by indicating that any COUNT values smaller than the FRC value and having not been received yet, upon being notified, are to be considered as among the one or more discarded COUNT values.

In some embodiments, the COUNT information may indicate a hyper frame number (HFN) value of a first resumed COUNT (FRC) value. The FRC value may be associated with a second PDCP data PDU. The second PDCP data PDU may be an earliest PDCP data PDU to be transmitted to the second PDCP entity when the transmission to the second PDCP entity is resumed. The FRC value may be a smallest COUNT value used after the transmission to the second PDCP entity is resumed and being greater than any of the one or more discarded COUNT values. The HFN value may be a value expressed by a pre-specified number of most significant bits of the FRC value.

In some embodiments, the first PDCP entity may notify the second PDCP entity about the COUNT information by sending to the second PDCP entity the COUNT information in a PDCP control PDU, in response to discarding the first PDCP data PDU.

In some embodiments, the first PDCP entity may determine, after discarding the first PDCP data PDU and before notifying the second PDCP entity, a need to resume transmission to the second PDCP entity.

In some embodiments, the first PDCP entity may notify the second PDCP entity about the COUNT information by sending to the second PDCP entity the COUNT information in a PDCP control PDU, in response to the determining the need to resume the transmission to the second PDCP entity.

In some embodiments, the COUNT information may further indicates that the one or more discarded COUNT values are not to be reused for processing another PDCP SDU for second transmission to the second PDCP entity.

In some embodiments, the first PDCP entity may determine that the one or more discarded COUNT values cannot be reused for processing another PDCP SDU before sending the COUNT information to the second PDCP entity.

In some embodiments, the first device may be a user equipment (UE), and the second device may be a base station. In some embodiments, the first device may be a base station, and the second device may be a UE. In some embodiments, the first device and the second device may be peer UEs.

In some embodiments, the first PDCP entity may process the PDCP SDU by performing integrity protection and ciphering for the PDCP SDU by using the COUNT value.

According to embodiments, a first PDCP entity receives, from a second PDCP entity of a second device, COUNT information related to one or more discarded COUNT values. The one or more discarded COUNT values is respectively associated with one or more PDCP data protocol data units (PDUs) that have been discarded by the second PDCP entity. The second PDCP entity is a peer PDCP entity of the first PDCP entity for processing data for transmission to the first device. The first PDCP entity receives from the second PDCP entity a PDCP data PDU. The first PDCP entity processes the PDCP data PDU to produce a PDCP service data unit (SDU) based on the COUNT information. The first PDCP entity delivers the PDCP SDU to an associated upper layer without waiting for the one or more PDCP data PDUs associated with the one or more discarded COUNT values.

In some embodiments, the first PDCP entity may process the PDCP data PDU based on the COUNT information by determining a COUNT value associated with the PDCP data PDU using the COUNT information.

In some embodiments, the COUNT information may indicate a first discarded COUNT (FDC) value. The FDC value may be a smallest COUNT value among the one or more discarded COUNT values.

In some embodiments, the COUNT information may further include a bitmap indicating additionally discarded COUNT values. The one or more discarded COUNT values may include the FDC value and the additionally discarded COUNT values. Each bit in the bitmap may correspond to a unique COUNT value among a sequence of contiguous COUNT values. The sequence of contiguous COUNT values may immediately follow the FDC value numerically and comprise the additionally discarded COUNT values. The each bit in the bitmap may carry either a first value indicating that a corresponding COUNT value is associated with a corresponding discarded PDCP PDU or a second value indicating that the corresponding COUNT value is unassociated with any of the discarded PDCP PDUs.

In some embodiments, the first PDCP entity may determine a largest COUNT value among the one or more discarded COUNT values to be a COUNT value corresponding to a last bit set to the first value in the bitmap.

In some embodiments, the COUNT information may further indicate a total number of additionally discarded COUNT values. The one or more discarded COUNT values may include the FDC value and a number of contiguous COUNT values immediately following the FDC value numerically. The number may be equal to the total number indicated.

In some embodiments, the first PDCP entity may determine a largest COUNT value among the one or more discarded COUNT values to be equal to a sum of the FDC value and the total number indicated by the COUNT information.

In some embodiments, the COUNT information may indicate a last discard COUNT (LDC) value, the LDC value being a largest COUNT value among the one or more discarded COUNT values.

In some embodiments, the first PDCP entity may update a state variable RX_NEXT of the first PDCP entity to be equal to a sum of one and the largest COUNT value among the one or more discarded COUNT values in response to determining that the sum is greater than an RX_NEXT value prior to the updating.

In some embodiments, the first PDCP entity may update a state variable RX_DELIV

of the first PDCP entity to be equal to a sum of one and the largest COUNT value among the one or more discarded COUNT values.

In some embodiments, the first PDCP entity may update a state variable RX_DELIV of the first PDCP entity to be equal to a smallest COUNT value satisfying all of being greater than an RX_DELIV value prior to the updating, being greater than or equal to a sum of one and the largest COUNT value among the one or more discarded COUNT values, and a PDCP SDU associated with which has not been delivered to upper layer associated with the first PDCP entity yet and is still waited for.

In some embodiments, the first PDCP entity may determine COUNT values that are smaller than the LDC value and have not been received yet as being among the one or more discarded COUNT values.

In some embodiments, the COUNT information may indicate a first resumed COUNT (FRC) value. The FRC value may be associated with a second PDCP data PDU. The second PDCP data PDU may be an earliest PDCP data PDU to be transmitted by the second PDCP entity upon being notified, and the FRC value being a smallest COUNT value to be used in transmitting a next PDCP data PDU by the second PDCP entity upon notifying the first PDCP entity.

In some embodiments, the first PDCP entity may update a state variable RX_NEXT of the first PDCP entity to be equal to the FRC value indicated by the COUNT information in response to determining that the FRC value is greater than an RX_NEXT value prior to the updating.

In some embodiments, the first PDCP entity may update a state variable RX_DELIV of the first PDCP entity to be equal to the FRC value indicated by the COUNT information.

In some embodiments, the first PDCP entity may update a state variable RX_DELIV of the first PDCP entity to be equal to a smallest COUNT value satisfying all of being greater than an RX_DELIV value prior to the updating, being greater than or equal to the FRC value being notified, and a PDCP SDU associated with which has not been delivered to upper layer associated with the first PDCP entity yet and is still waited for.

In some embodiments, the first PDCP entity may determine COUNT values that are smaller than the FRC value and have not been received yet as being among the one or more discarded COUNT values.

In some embodiments, the COUNT information may indicate a hyper frame number (HFN) value of a first resumed COUNT (FRC) value. The FRC value may be associated with a second PDCP data PDU. The second PDCP data PDU may be an earliest PDCP data PDU to be transmitted from the second PDCP entity upon being notified. The FRC value may be a smallest COUNT value to be used in transmitting a next PDCP data PDU by the second PDCP entity upon notifying the first PDCP entity.

In some embodiments, the first PDCP entity may receive the COUNT information by receiving the COUNT information in a PDCP control PDU.

In some embodiments, the first PDCP entity may determine that the one or more PDCP PDUs associated with the one or more discarded COUNT values are not to be waited for.

In some embodiments, the first PDCP entity may consider that the one or more PDCP PDUs associated with the one or more discarded COUNT values as if having been received and delivered to upper layer associated with the first PDCP entity.

In some embodiments, the first device may be a user equipment (UE), and the second device may be a base station. In some embodiments, the first device may be a base station, and the second device may be a UE. In some embodiments, the first device and the second device may be peer UEs.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example communications system, according to some embodiments;

FIG. 1B shows an example of a transmitting PDCP entity on a data sender side and a receiving PDCP entity on a data recipient side for data transfer in one direction, according to some embodiments;

FIG. 2 illustrates an example PDCP data protocol data unit (PDU) format with a 12-bit PDCP SN, according to some embodiments;

FIG. 3 shows an example network architecture, according to some embodiments;

FIG. 4A illustrates an example PDCP Transmitting Status control PDU, according to some embodiments;

FIG. 4B illustrates an example PDCP Transmitting Status control PDU, according to some embodiments;

FIG. 4C illustrates an example PDCP Transmitting Status control PDU, according to some embodiments;

FIG. 5A illustrates an example PDCP control PDU, according to some embodiments;

FIG. 5B illustrates an example PDCP control PDU, according to some embodiments;

FIG. 6 illustrates a flow diagram of an example flow occurring in a PDCP entity of a transmitting device, according to some embodiments;

FIG. 7 illustrates a flow diagram of an example flow occurring in a PDCP entity of a receiving device, according to some embodiments;

FIG. 8 illustrates a flow diagram of an example flow occurring in a PDCP entity of a transmitting device, according to some embodiments;

FIG. 9 illustrates a flow diagram of an example flow occurring in a PDCP entity of a receiving device, according to some embodiments;

FIG. 10A illustrates a flow chart of a method performed by a first PDCP entity of a first device, according to some embodiments;

FIG. 10B illustrates a flow chart of a method performed by a first PDCP entity of a first device, according to some embodiments;

FIG. 11 illustrates an example communication system, according to some embodiments;

FIGS. 12A and 12B illustrate example embodiment devices that may implement the methods and teachings according to this disclosure; and

FIG. 13 is a block diagram of a computing system that may be used for implementing the devices and methods disclosed herein, according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

The embodiments of this disclosure provide a packet handling mechanism enabling differential QoS handling of packets of different types of application data units within a same service stream. The mechanism provides means for classifying packets of different types of application data units within a same service stream (such as a video stream of an extended reality (XR) service) in accordance with pre-configured classification rules and parameters, and PDU set related information conveyed with each packet of the video stream. The mechanism also provides means for discarding a packet in accordance with the PDU set related information when a congestion condition is met, or when a delivery deadline associated with the packet has passed without the packet having been delivered successfully, or when another application data unit that the packet is dependent upon has not been transmitted successfully.

The embodiments of this disclosure also provide a signaling mechanism for the transmitting PDCP entity to notify the receiving PDCP entity about one or more COUNT values that are associated with PDCP PDUs having been discarded and are not to be reused for transmitting another PDCP SDU from the transmitting PDCP entity to the receiving PDCP entity, and therefore are not to be waited for.

The embodiment techniques avoid wasting valuable radio resources on unnecessary transmissions that do not improve the user experience.

The notification (conveyed by, for example, the PDCP Transmitting Status control PDU) enables the receiving PDCP entity to avoid holding off subsequently received PDCP SDU(s) from delivery to the upper layer due to performing unnecessary reordering procedure, which would otherwise be triggered (and carried on until being timed out) as a result of not receiving the discarded PDCP PDUs and not being notified with. Unless being specifically described as a PDCP control PDU (i.e., a PDCP PDU with a control type, as indicated by a value zero in the data/control (D/C) field in the PDCP header), PDCP PDUs described herein, which carry upper layer data and may be subject to being discarded, are referring to the PDCP data PDUs, which are PDCP PDUs with a data type, as indicated by a value one in the D/C field in the PDCP header. A PDCP data PDU is generated by a PDCP entity (referred to as the transmitting PDCP entity) of a communication device for transferring a PDCP SDU (i.e., upper layer data) to a peer PDCP entity (referred to as the receiving PDCP entity) of another communication device. On the other hand, a PDCP control PDU (such as the PDCP Transmitting Status control PDU described herein) is generated by a first PDCP entity for conveying a PDCP control message to its peer PDCP entity, the control message being originated at the first PDCP entity to manage the operations between the two PDCP entities, e.g., to report a status or to send a feedback information, etc.

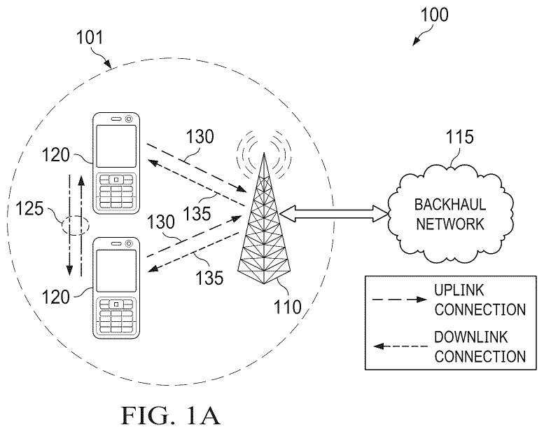

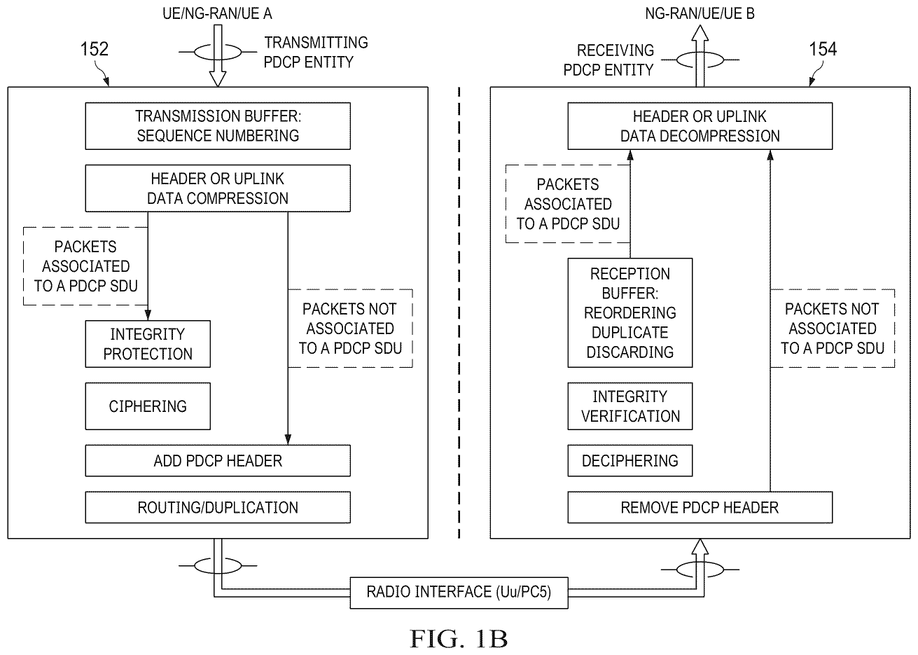

FIG. 1A illustrates an example communications system 100, according to embodiments. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1A, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

FIG. 1B illustrates an example of a transmitting PDCP entity 152 on a data sender side and a receiving PDCP entity 154 on a data recipient side for data transfer in one direction. In some embodiments, the data sender and the data recipient may be a UE and a next generation radio access network (NG-RAN) node (e.g., a gNB for 5G NR), respectively, or vice versa, or two peer UEs. For a bi-directional data radio bearer (DRB) where data can be transferred in both directions, there is an additional pair of transmitting PDCP entity and receiving PDCP entity (not shown in FIG. 1B) for data transfer in the opposite directions.

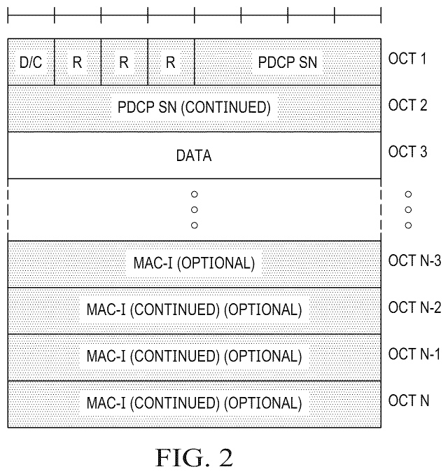

As shown in FIG. 1B, when receiving an upper layer data packet (also referred to as the PDCP SDU) from its associated upper layer for transmission, the transmitting PDCP entity 152 associates a unique integer number referred to as the COUNT value with the PDCP SDU, the COUNT value being incremented by one for every subsequent PDCP SDU and being used in performing integrity protection and ciphering on the associated PDCP SDU. If header compression is configured on the DRB by the radio resource control (RRC) signaling, the transmitting PDCP entity 152 compresses certain upper layer protocol header(s) in accordance with the configured header compression profile(s) before performing the integrity protection and ciphering on the header-compressed PDCP SDU. Then, the transmitting PDCP entity 152 generates a PDCP PDU including a PDCP header, a data payload, and a message authentication code for integrity (MAC-I), the data payload encapsulating the header-compressed, integrity-protected, and ciphered PDCP SDU, and the PDCP header including a PDCP SN, which is a pre-configured number of least significant bits (LSBs) of the COUNT value associated with the PDCP SDU. In accordance with the current 3GPP PDCP specification (TS 38.323 v17.4.0), the PDCP SN can be either 12 bits or 18 bits long (FIG. 2 illustrates an example PDCP data PDU format with a 12-bit PDCP SN). Then, the transmitting PDCP entity submits the PDCP PDU to its associated lower layer for the transmission.

On the data recipient side, upon receiving a PDCP PDU from its associated lower layer, the receiving PDCP entity 154 retrieves the PDCP SN (from the PDCP header), the data (payload), and the MAC-I from the received PDCP PDU. The receiving PDCP entity reconstructs a COUNT value using the retrieved PDCP SN and a reconstructed hyper frame number (HFN) value, the reconstructed HFN value being reconstructed by the receiving PDCP entity 154 to track the un-transmitted remaining portion (i.e., un-transmitted most significant bits (MSBs) excluding the PDCP SN bits) of the COUNT value used by the transmitting PDCP entity on the received PDCP PDU. For example, the reconstructed HFN value is determined based on a value of the HFN portion of a state variable of the receiving PDCP entity referred to as the RX_DELIV and a comparison between the values of the retrieved PDCP SN and the PDCP SN portion of the RX_DELIV, the RX_DELIV being used for tracking the COUNT value of the first PDCP SDU not delivered to the associated upper layer of the receiving PDCP entity but still waited for. The receiving PDCP entity 154 uses the reconstructed COUNT value to decipher the retrieved data payload and to verify the integrity of the deciphered data payload. The receiving PDCP entity also uses the reconstructed COUNT values among the integrity-verified data payloads received to perform duplicate detection and discarding, and if necessary, to perform reordering for in-order delivery. If header compression is configured, the receiving PDCP entity decompresses (i.e., reconstructs) the upper layer headers in accordance with the configured header compression profiles in order to fully reconstruct the PDCP SDU before delivering the PDCP SDU to its associated upper layer. In addition to RX_DELIV, a receiving entity also maintains other state variables such as RX_NEXT and RX_REORD. RX_NEXT is used for tracking the COUNT value of the next PDCP SDU expected to be received and RX_REORD is used for tracking the COUNT value following the COUNT value associated with the PDCP PDU which triggered the starting of a timer referred to as the t-Reordering timer. If the t-Reordering timer is not subsequently stopped and reset by successfully reception of the missing PDCP PDU(s), then upon the expiry of the t-Reordering timer, any PDCP PDUs with a COUNT value less than the value of RX_REORD and having not been received yet will be considered as finally lost in the transmission and not to be waited for anymore. In this situation (i.e., the timer expired), RX_DELIV will be updated to the COUNT value of a new first PDCP SDU not delivered to the associated upper layer of the receiving PDCP entity but still waited for, the COUNT value being greater than RX_REORD (meaning that the receiving PDCP entity will search for the new first PDCP SDU not delivered yet only from RX_REORD and onwards). Then, if the updated value of RX_DELIV is less than the value of RX_NEXT, it is determined that transmission of a PDCP PDU with a COUNT value equal to the updated value of RX_DELIV has started but has not been successful yet and hence at least one new missing PDCP PDU is identified. Then, in response to identifying the new missing PDCP PDU, the receiving PDCP entity updates RX_REORD to be equal to the value of RX_NEXT and starts t-Reordering timer again.

Extended reality (XR) services are expected to be an important driving force for developing the next generation wireless communication technologies. The data traffic in XR services usually includes a stream of video data corresponding to video pictures (also referred to as frames) that are periodically generated by the video codec (e.g., in the XR server, or in the AR client for the uplink (UL) video). A video picture is usually sliced, compressed, and encoded into a number of coded units. For example, in H.264, these coded units are referred to as the network adaptation layer (NAL) units, the first byte of the NAL unit being an NAL unit header that contains an indication of the type of data in the NAL unit. A group of NAL units may belong to a same application data unit, the application data unit (which is also referred to as the media data unit) corresponding to a picture or a layer representation (such as a base layer, a spatial enhancement layer, a temporal enhancement layer, or a quality enhancement layer) of a picture. When transferred over a transport network, each NAL unit is usually encapsulated in one or more cascaded real-time protocol (RTP)/user datagram protocol (UDP)/internet protocol (IP) packets for end-to-end delivery to a video decoder (e.g., in the XR client, or in the AR server for the UL video). Such a delivery may involve a transmission over a wireless link between a gNB and a UE, the gNB being connected with the XR server, usually through a wireline connection, and the UE being co-located and/or connected with the XR client. Upon receiving these RTP/UDP/IP packets from an associated upper layer, the service data adaptation protocol (SDAP) entity of the gNB (for the DL transmission) or that of the UE (for the UL transmission) further encapsulates each of these RTP/UDP/IP packets in an SDAP PDU, the SDAP PDU arriving at the transmitting PDCP entity of the gNB or that of the UE as a PDCP SDU. Then, the transmitting PDCP entity of the gNB or the UE processes the PDCP SDU to produce a PDCP PDU and submits the PDCP PDU to its associated lower layer for transmission, as described before.

Because the video decoder processes a received video application data unit as a whole, the RTP/UDP/IP/SDAP/PDCP packets (PDUs) associated with a same video application data unit should be handled in an integrated manner at each respective protocol layer during the end-to-end delivery. The RTP/UDP/IP/SDAP/PDCP packets (PDUs) associated with a same video application data unit are also collectively referred to as a PDU set. Therefore, an application data unit and its corresponding PDU set may be considered as the same (or at least carrying a same media content), except that the former is more used in the application layer and the latter is recently introduced in 3GPP TS 23.700-60 for handling these packets (or PDUs) by a respective protocol layer as they are transferred over the transport network or over the RAN. For example, at the RTP layer, a PDU set refers to all the RTP packets associated with a same video application data unit. At the UDP layer, a PDU set refers to all the UDP packets associated with a same video application data unit. At the IP layer, a PDU set refers to all the IP packets associated with a same video application data unit. At the SDAP sublayer, a PDU set refers to all the SDAP data PDUs associated with a same video application data unit. At the PDCP sublayer, a PDU set refers to all the PDCP data PDUs associated with a same video application data unit. At the radio link control (RLC) sublayer, a PDU set refers to all the RLC data PDUs associated with a same video application data unit.

To ensure a user of an XR service can enjoy the experience of immersiveness and cyber-reality, the video resolution required for XR services is usually very high. For example, a 4K video is required to achieve the retina resolution with a head mounted display (HMD), which is only a few centimeters away from the human eye, compared to 1080p video required to achieve the same on a smartphone screen. Higher resolution translates to higher peak data rate and higher average throughput, and as a result, higher chance of creating network congestion, especially in a radio access network (RAN). New techniques for handling the transmissions of such high volume of data when network congestion occurs are needed to alleviate the network congestion and to minimize the impacts on user experience.

Due to the real-time and interactive nature of XR services and human physiology, an end-to-end delay, which is referred to as the motion-to-photon delay, needs to be very short (e.g., no longer than 20 milliseconds (msec)); otherwise, the user may experience cyber-sickness such as feeling dizzy, disoriented, and nauseous. Therefore, the delay requirements for the video traffics of an XR service are usually very stringent. New methods for efficiently handling the data transmission when the delay requirements may not be met from time to time may be needed to improve the efficiency in utilizing transmission resources in the network, especially in a RAN.

Conventional enhanced mobile broadband (eMBB) traffic usually requires high peak data rate and high throughput without stringent delay requirements. Conventional ultra reliable low latency communications (URLLC) traffics usually require low latency and high reliability, but the peak data rate and throughput required for the conventional URLLC use cases (such as sensors or industrial control) tend to be relatively low, compared to the XR use cases. Therefore, the existing wireless technologies developed for the eMBB and URLLC traffics are insufficient for handling the XR traffics. New methods are needed to simultaneously meet the requirements of high peak data rate, high throughput, high reliability, and low latency.

The technical solutions in this disclosure first provide a framework for enabling differential QOS handling of packets of different types of application data units (i.e., PDU sets) within a same video stream. The framework provides means for classifying packets of different types of application data units within a same video stream in accordance with pre-configured classification rules and PDU set related information conveyed with each packet of the video stream. The framework also provides means for discarding a packet in accordance with the PDU set related information when a congestion condition is met, or when a delivery deadline associated with the packet has passed without the packet having been delivered successfully, or when another application data unit that the packet is dependent upon has not been transmitted successfully.

The technical solutions in this disclosure also provide signaling means for the transmitting PDCP entity to notify the receiving PDCP entity about one or more COUNT values associated with discarded PDCP PDUs and not to be reused after the PDCP PDUs are discarded or to notify the receiver about a first resumed transmission when the transmission of PDCP PDUs resumes. For examples, the PDCP PDUs may be discarded due to a congested condition, due to missing a delivery deadline, due to being dependent on a preceding PDU set and the transmission of the preceding PDU set being unsuccessful, etc. Such notification enables the receiving PDCP entity to avoid holding off subsequently received PDCP SDU(s) from delivery to the associated upper layer due to performing an unnecessary reordering procedure, which would otherwise be triggered and carried on as a result of not receiving the discarded PDCP PDUs and not being notified with.

An XR service typically uses an advanced codec (such as H.264 or H.265) for the video stream, wherein different application data units may be of different types, may be associated with different levels of importance, and/or may have different statuses of dependency on another application data unit within the same video stream.

Taking H.264 advanced video coding (AVC) for an example, periodically, an application data unit is produced as an intra-coded (I) picture, which is a picture that is encoded independently of all other pictures. An I picture is usually followed by a number of application data units referred to as the predictive coded (P) pictures or bi-predictive coded (B) pictures until the same pattern is repeated at the next I picture, and so on and so forth. The P pictures and the B pictures are compressed and encoded either by directly using the I picture as a reference picture or by using another preceding P picture to reconstruct another reference picture for the inter-picture prediction. The another preceding P picture can be compressed and encoded by directly using the I picture as the reference picture or by using yet another preceding P picture to reconstruct yet another reference picture for the inter-picture prediction, and so on and so forth. The B pictures are not used as a reference picture for any inter-picture prediction. Therefore, the successful decompression of the P pictures and the B pictures (to reconstruct their associated full pictures) depends on the successful reception and decompression of their respective reference pictures. If the I picture is lost (i.e., not received by the video decoder), all the subsequently received P pictures and B pictures (before the next I picture) become useless, even if they are received successfully. In this situation, the I pictures are more important than the P pictures and the B pictures, and therefore requires a higher priority and higher reliability during transmission. A P picture being dependent by another P picture or B picture is more important than a P picture not being dependent upon and is more important than a B picture. The B pictures are the least important pictures, because no other pictures are dependent on them, and therefore may be handled with a lower priority and lower reliability during transmission. Therefore, when experiencing a congested condition, the gNB or the UE may first discard packets (or PDUs) of application data units corresponding to the lowest priority, such as the P pictures not being dependent upon and the B pictures, to alleviate the congestion condition, and if the congested condition persists, may further discard packets (or PDUs) of application data units corresponding the second lowest priority, such as the P pictures being dependent upon, and so on and so forth. The type of an application data unit associated with data carried in an NAL unit is indicated by an nal_unit_type field in the NAL unit header, the NAL unit header comprising the first octet of the NAL unit, the NAL unit (or a fragment thereof when the NAL unit is oversized) being encapsulated as a payload in a cascaded RTP/UDP/IP packet. In addition to differentiating the handling of packets of different application data units based on the types of the application data units, H.264 also allows the video encoder to provide an indication of a reference or dependency level via a num_ref_idc field in the NAL unit header. A binary value of ‘00’ in the 2-bit num_ref_idc field indicates that the content of the NAL unit is not used to reconstruct reference pictures for inter-picture prediction. Such NAL units can be discarded without risking the integrity of the reference pictures. Values greater than ‘00’ indicate that the decoding of the NAL unit is required to maintain the integrity of at least some of the reference pictures. The highest priority is ‘11’, followed by ‘10’, and then by ‘01’; finally, ‘00’ is the lowest. Such (multi-level) codepoints for importance/dependency indication provide the ability to indicate multiple levels of dependency (and therefore multiple levels of importance) when hierarchical inter-picture dependency is used.

Taking the H.264 scalable video coding (SVC) extension for another example, the video codec divides a video stream into a sub-stream of base layer application data units and a number of sub-streams of enhancement layer application data units, each base layer application data unit being self-decodable, providing a lower spatial resolution picture, which is used as a reference picture for the enhancement layer application data units that are dependent on it. For examples, spatial enhancement layer application data unit(s) may be produced to provide better spatial resolution, temporal enhancement layer application data unit(s) may be produced to provide better temporal resolution, and quality enhancement layer application data unit(s) may be produced to provide better quality (or fidelity) in a reconstructed picture. So, the base layer application data units are generally more important than the enhancement layer application data units and therefore requires a higher priority and higher reliability during transmission, compared to the enhancement layer application data units. In addition, according to IETF RFC 6190 (entitled “RTP Payload Format for Scalable Video Coding”), the H.264 SVC encoder indicates a priority level of an NAL unit with a more refined granularity by using a 6-bit priority_id (PRID) field in an NAL unit type-specific extension header, the NAL unit type-specific extension header being specific for SVC type of NAL units and comprising the second to the fourth octets of the NAL unit. A lower value of PRID field indicates a higher priority. The H.264 SVC encoder also indicates the inter-layer coding dependency level of a layer application data unit associated with an SVC type of NAL unit by using a 3-bit dependency_id (DID) field in the NAL unit type-specific extension header. A layer application data unit with a given dependency_id may be used for inter-layer prediction for coding of another layer application data unit with a higher dependency_id, while a layer application data unit with a given dependency_id shall not be used for inter-layer prediction for coding of a layer application data unit with a lower dependency_id. Hence, the PRID and DID information may be used for differentiating the handling of packets of different types of layer application data units during the end-to-end delivery.

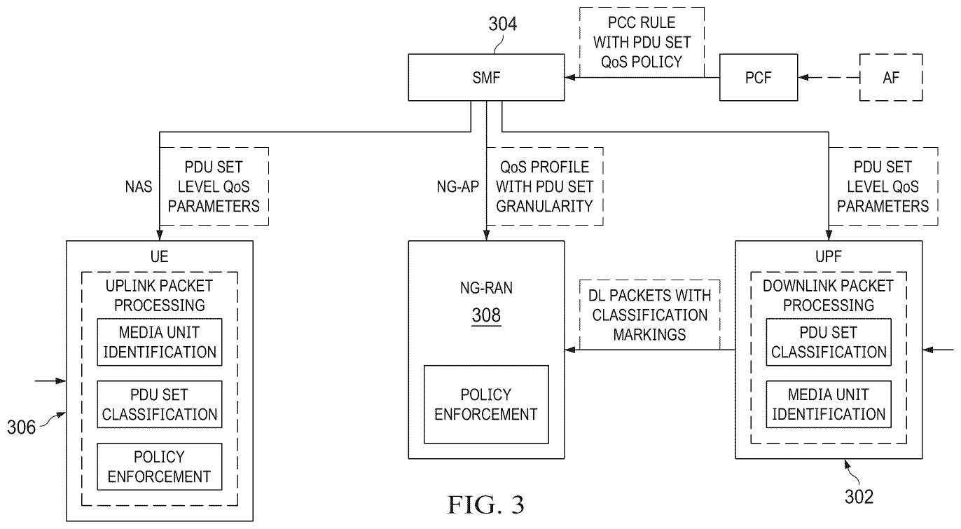

As shown in FIG. 3, the user plane function (UPF) 302 (for the DL video transmission) or the UE 306 (for the UL video transmission), after identifying incoming RTP/UDP/IP packets belonging to a same video stream of an XR service running on the UE 306 by using the conventional packet filtering, which may be based on the 5-tuples (i.e., source/destination IP addresses, source/destination port numbers, and protocol ID), further classifies the identified RTP/UDP/IP packets by inspecting various fields in the RTP header, the NAL unit header, and/or the NAL unit type-specific extension header, as described above, the classifying being based on rules and parameters provided by the session management function (SMF) 304 serving the data PDU session established for the video stream of the XR service. After classification, the UPF 302 maps the DL packets (or the UE 306 maps the UL packets) corresponding PDU sets of different priority levels and/or different reliability requirements to different QoS flows or to different QoS sub-flows of a same QoS flow, each QoS flow being uniquely identified with a QoS flow ID (QFI), and each QOS sub-flow being uniquely identified with a QoS sub-flow ID in addition to the QFI of the common QoS flow.

For the DL video transmission, the UPF 302 forwards each classified RTP/UDP/IP packet (which is further encapsulated in a general packet radio service (GPRS) Tunneling Protocol (GTP)-user plane (GTP-U) packet for transfer over a GTP tunnel between the UPF 302 and the gNB in the next generation RAN (NG-RAN)) to the NG-RAN node 308 (i.e., the gNB) serving the UE, along with the associated QFI, QOS sub-flow ID, and additional PDU set related information (carried in the GTP-U extension header of the GTP-U packet). Examples of the additional PDU set related information includes the PDU set size (e.g., the total number of packets) of a PDU set that a packet belongs to, a start marker and/or an end marker indicating whether the packet is the first packet or the last packet, respectively, within the PDU set that the packet belongs to, a PDU set SN of the PDU set that the packet belongs to, a PDU SN indicating the position of the packet within the PDU set that the packet belong to, inter-PDU-set dependency information, etc. For example, the inter-PDU-set dependency information may be an indication indicating whether the PDU set that the packet belongs to is dependent on a second PDU set. For another example, the inter-PDU-set dependency information may be the PDU set SN of a second PDU set, the PDU set that the packet belongs to being dependent upon the second PDU set. From the received GTP-U packets, a GTP-U interface unit of the gNB retrieves and passes on the RTP/UDP/IP packets, and the QFI, the QoS sub-flow ID, and the additional PDU set related information associated with each of the RTP/UDP/IP packets to a SDAP entity of the gNB, the SDAP entity being established to serve a data PDU session that has been configured for the video stream of the XR service. The SDAP entity may encapsulate each of the RTP/UDP/IP packets in a SDAP PDU, respectively, and submit each produced SDAP PDU to a transmitting PDCP entity among multiple transmitting PDCP entities of the gNB in accordance with the QFI and the QoS sub-flow ID associated with the each of the produced SDAP PDUs, respectively, each of the multiple transmitting PDCP entities being configured to serve a unique DRB that is configured to meet a different level of QoS requirements. The SDAP entity may also provide the transmitting PDCP entity with the additional PDU set related information associated with the SDAP PDU submitted to the transmitting PDCP entity. For the UL video transmission, the QFI, the QoS sub-flow ID, similar additional PDU set related information can also be passed along with the RTP/UDP/IP packets internally within the UE 306, across different layers until arriving at the transmitting PDCP entity of the UE 306, by UE implementations.

Then, the transmitting PDCP entity in the gNB (for DL) or in the UE (for UL) can use the PDU set related information to handle the packets accordingly. For example, the PDU set SN, the PDU set size information, the PDU SN, the start marker, and/or the end marker associated with a packet may assist the transmitting PDCP entity to determine whether it has successfully transmitted all the packets of a PDU set that the packet belongs to, before a delivery deadline. And in a situation where the transmitting PDCP entity is unable to successfully transmit a packet of the PDU set before the delivery deadline, the transmitting PDCP entity may discard the remaining packets of the same PDU set without attempting to transmit them, the remaining packets may be identified by the PDU set SNs and the PDU SNs associated with them. The transmitting PDCP entity may further determine whether the abandoned PDU set is being dependent upon by packets of a second PDU set. For example, packets of the second PDU set are subsequently received by the transmitting PDCP entity for transmission and the inter-PDU-set dependency information associated with each of the packets of the second PDU set indicates the PDU set SN of the abandoned PDU set (meaning that they are dependent on the abandoned PDU set). In response to determining that the second PDU set is dependent on the abandoned PDU set, the transmitting PDCP entity may discard all the packets of the second PDU set as well, because transmitting them may be wasteful as the video decoder will be unable to decompress the picture successfully to generate a full picture without receiving all the packets of the abandoned PDU set. Discarding packets to avoid unnecessary transmissions will help to avoid wasting valuable radio resources on transmissions that would not improve the user experience.

In order to reduce packet processing delay, PDCP PDUs are usually pre-processed, meaning that the time-consuming computation related to header compression, integrity protection, and ciphering on a PDCP SDU is usually finished before the associated lower layer indicates an opportunity for the transmission. As described before, the COUNT value associated to the PDCP SDU is used in the computation for integrity protection and ciphering on the PDCP SDU. As the transmitting PDCP entity of the gNB (for DL) or of the UE (for UL) may discard the pre-processed PDCP PDUs of an abandoned PDU set from time to time (e.g., due to missing the delivery deadline because of transmission errors or a congestion condition, or due to the reference application data unit, which the pre-processed PDCP PDUs are dependent upon, has been abandoned), the transmitting PDCP entity may not have the time for re-assigning the COUNT values associated with the discarded PDCP PDUs to subsequent PDCP SDUs, and more importantly, the transmitting PDCP entity may not have the time and computing resources to repeat the computation for integrity protection and ciphering on those subsequent PDCP SDUs, if those subsequent PDCP SDUs have already been received (from upper layer for transmission) and pre-processed by the transmitting PDCP entity; otherwise, repeating the computation may cause the delivery deadline for those subsequent PDCP SDUs to also be missed.

On the other hand, not reusing the discarded COUNT values on subsequent PDCP SDUs will create a situation where the receiving PDCP entity considers that the associated PDCP PDUs are still in the mid of the transmission without knowing that their transmissions have been abandoned by the transmitting PDCP entity, hence triggering a re-ordering procedure, i.e., waiting for the missing PDCP PDUs to be received. And while waiting, the receiving PDCP entity may hold off subsequently received PDCP SDUs from delivery to the associated upper layer until the re-ordering procedure times out, if in-order delivery is configured, and therefore artificially increasing the delay for delivering those subsequently received packets. In addition, missing a large chuck of consecutive COUNT values may also cause the receiving PDCP entity to generate a wrong HFN value for reconstructing the COUNT value for a subsequently received PDCP PDU. The wrong HFN value and hence the wrong COUNT value will cause failures in deciphering and integrity verification for the subsequently received PDCP PDU, even if the latter is authentic and is received without any error.

According to various embodiments, the transmitting PDCP entity notifies the receiving PDCP entity about the COUNT values associated with the PDCP PDUs that have been discarded and not to be reused in transmitting subsequent PDCP PDUs. For example, the transmitting PDCP entity sends a PDCP control PDU referred to as the PDCP Transmitting Status control PDU whenever the transmitting PDCP entity discards PDCP PDU(s) without reusing the COUNT values associated with the discarded PDCP PDU(s) on subsequent PDCP SDU(s). The PDCP Transmitting Status control PDU may also be referred to as, for example the PDCP Discarding Status control PDU, or simply as the Transmitting Status control PDU or the Discarding Status control PDU, etc.

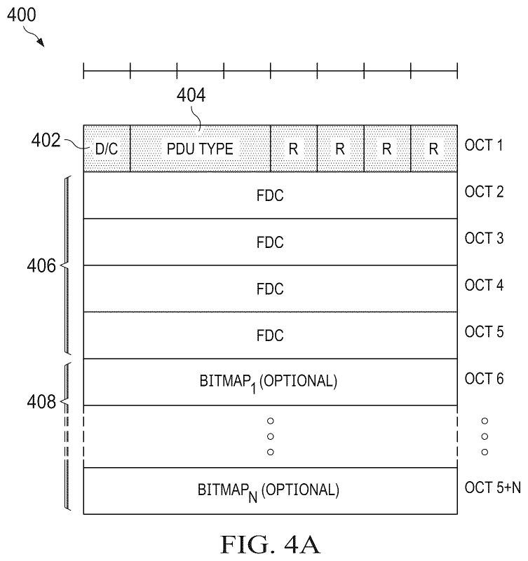

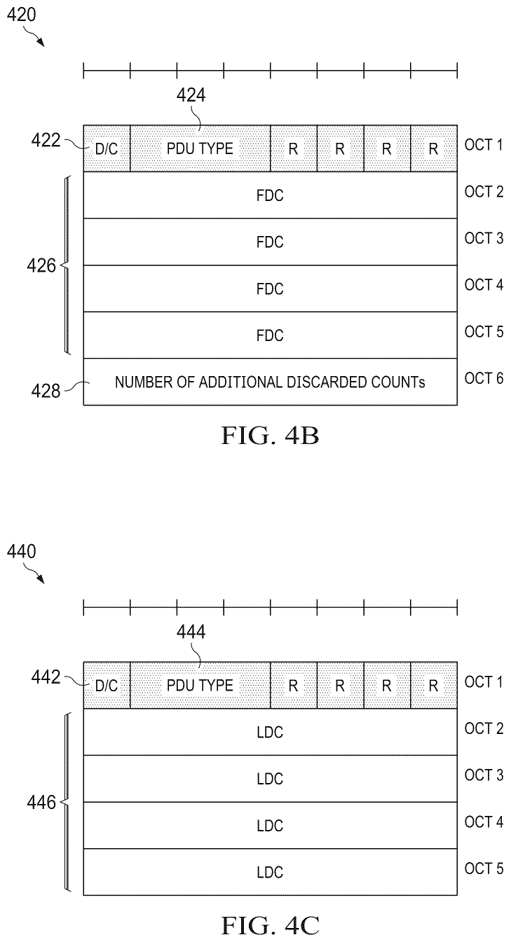

In accordance with one example embodiment, as illustrated in FIG. 4A, the PDCP Transmitting Status control PDU 400 includes a D/C field 402 carrying a value of o (zero) indicating that the PDCP PDU is a control PDU, a PDU type field 404 carrying a value corresponding to the PDCP Transmitting Status control PDU type, and a first discarded COUNT (FDC) field 406 carrying an FDC value, the FDC value being the first (i.e., the smallest) COUNT value among the COUNT values associated with the discarded PDCP PDUs and not to be reused. When there are more than one discarded PDCP PDUs (without reusing the associated COUNT values), the PDCP Transmitting Status control PDU also includes a bitmap field 408 carrying a bitmap indicating the discarding statuses (e.g., “discarded” or “not discarded”) of consecutive COUNT values that follow the FDC value. For example, the first bit in the bitmap corresponds to the first COUNT value following the FDC value, the second bit in the bitmap corresponds to the second COUNT value following the FDC value, and so on and so forth. For example, a value of o (zero) carried by a bit in the bitmap indicates that the corresponding COUNT value has not been discarded (i.e., “not discarded”), and a value of 1 carried by the bit indicates that the corresponding COUNT value has been discarded and is not to be reused on a subsequent PDCP SDU (i.e., “discarded”), thereby notifying the receiving PDCP entity not to wait for it. The opposite logic for the indicating is also possible. Padding bits may be added at the end of the bitmap in order to keep the size of the bitmap to be an integer number of octets. All padding bits may be set to the value that indicates the corresponding COUNT value has not been discarded.

When receiving the PDCP Transmitting Status control PDU 400, as illustrated in FIG. 4A, the receiving PDCP entity may determine the COUNT value indicated by the FDC field 406 and any other COUNT values, of which the corresponding bit in the bitmap field 408 being set to a value indicating the status of “discarded,” either as having been discarded by the transmitting PDCP entity or as if having been received and delivered to upper layer, and hence, in either way, as not to be waited for. The receiving PDCP entity may further determine a largest COUNT value among the discarded COUNT values being notified. For example, the receiving PDCP entity determines that the largest COUNT value among the discarded COUNT values being notified is the one corresponding to the last bit set to a value indicating the status of “discarded” in the bitmap field 408. Based on such determination, the receiving PDCP entity may further update its state variables such as RX_NEXT, RX_DELIV, and RX_REORD, accordingly. For example, if the largest COUNT value among the discarded COUNT values being notified is greater than or equal to the value of RX_NEXT, the receiving PDCP entity updates RX_NEXT to be equal to the sum of one and the largest COUNT value among the discarded COUNT values being notified. Then, the receiving PDCP entity may further update its RX_DELIV. For example, the receiving PDCP entity updates its RX_DELIV to be equal to the sum of one and the largest COUNT value among the discarded COUNT values being notified (or simply be equal to the updated value of RX_NEXT). For another example, the receiving PDCP entity updates its RX_DELIV to be equal to a first (i.e., the smallest) COUNT value that satisfies all of the following: 1) being greater than the value of RX_DELIV (the one prior to the update of RX_DELIV); 2) being greater than the largest COUNT value among the discarded COUNT values being notified; and 3) a PDCP SDU associated with which has not been delivered to the upper layer yet and is still waited for. And then, if the current value of RX_DELIV is less than the current value of RX_NEXT, both values taken into account the possible update of the respective state variables, as described above, the receiving PDCP entity may further update its RX_REORD to be equal to the current value of RX_NEXT.

When the transmitting PDCP entity decides to abandon a PDU set, it may discard all the PDCP PDUs belonging to the PDU set if the transmission of the PDU set has not started yet or all the remaining PDCP PDUs belonging to the PDU set if some PDCP PDU(s) belonging to the PDU set has been transmitted. Therefore, the discarded COUNT values can be a large number of contiguous COUNT value. Hence, in accordance with an alternative example embodiment, as illustrated in FIG. 4B, the PDCP Transmitting Status control PDU 420 including the D/C field 422, the PDU type field 424, and the FDC field 426, as described before. And when there are more than one discarded PDCP PDUs (without reusing the associated COUNT values), the PDCP Transmitting Status control PDU also includes a Number of Additional Discarded COUNTs field 428 carrying a value indicating the total number of additionally discarded COUNT values that are contiguously following the FDC value. As shown in FIG. 4B, a single octet for the Number of Additional Discarded COUNTs field 428 is sufficient to indicate up to 256 additionally discarded COUNT values that are contiguously following the FDC value, compared to 1 to 16 octets for the bitmap field 408 in FIG. 4A that are needed to indicate up to 256 additionally discarded COUNT values that are contiguously following the FDC value.

When receiving the PDCP Transmitting Status control PDU 420, as illustrated in FIG. 4B, the receiving PDCP entity may determine the COUNT value indicated by the FDC field 426 and a number of consecutive COUNT values following the FDC, the number being indicated in the Number of Additional Discarded COUNTs field 428, either as having been discarded by the transmitting PDCP entity or as if having been received and delivered to upper layer, and hence, in either way, as not to be waited for. The receiving PDCP entity may further determine a largest COUNT value among the discarded COUNT values being notified. For example, the receiving PDCP entity determines the largest COUNT value among the discarded COUNT values being notified to be equal to the sum of the value in the FDC field 426 and the value in the Number of Additional Discarded COUNTs field 428. Based on such determination, the receiving PDCP entity may further update its state variables such as RX_NEXT, RX_DELIV, and RX_REORD, accordingly. For example, if the largest COUNT value among the discarded COUNT values being notified is greater than or equal to the value of RX_NEXT, the receiving PDCP entity updates RX_NEXT to be equal to the sum of one and the largest COUNT value among the discarded COUNT values being notified. Then, the receiving PDCP entity may further update its RX_DELIV. For example, the receiving PDCP entity updates its RX_DELIV to be equal to the sum of one and the largest COUNT value among the discarded COUNT values being notified (or simply be equal to the updated value of RX_NEXT). For another example, the receiving PDCP entity updates its RX_DELIV to be equal to a first (i.e., the smallest) COUNT value that satisfies all of the following: 1) being greater than the value of RX_DELIV (the one prior to the update of RX_DELIV); 2) being greater than the largest COUNT value among the discarded COUNT values being notified; and 3) a PDCP SDU associated with which has not been delivered to the upper layer yet and is still waited for. And then, if the current value of RX_DELIV is less than the current value of RX_NEXT, both values taken into account the possible update of the respective state variables, as described above, the receiving PDCP entity may further update its RX_REORD to be equal to the current value of RX_NEXT.

In accordance with another alternative example embodiment, as illustrated in FIG. 4C, the PDCP Transmitting Status control PDU 440 including the D/C field 442, the PDU type field 444, as described above, and a last discarded COUNT (LDC) field 446 carrying an LDC value, the LDC value being the last (i.e., the largest) COUNT value among the COUNT values associated with the discarded PDCP PDUs and not to be reused.

When receiving the PDCP Transmitting Status control PDU 440, as illustrated in FIG. 4C, the receiving PDCP entity may determine the COUNT value indicated by the LDC field 446 and any COUNT values prior to (i.e., smaller than) it and having not been successfully received yet, either as having been discarded by the transmitting PDCP entity or as if having been received and delivered to upper layer, and hence, in either way, as not to be waited for. Based on such determination, the receiving PDCP entity may further update its state variables such as RX_NEXT, RX_DELIV, and RX_REORD, accordingly. For example, if the value in the LDC field 446 is greater than or equal to the value of RX_NEXT, the receiving PDCP entity updates RX_NEXT to be equal to the sum of one and the LDC value being notified. Then, the receiving PDCP entity may further update its RX_DELIV. For example, the receiving PDCP entity updates its RX_DELIV to be equal to the sum of one and the LDC value being notified (or simply be equal to the updated value of RX_NEXT). For another example, the receiving PDCP entity updates its RX_DELIV to be equal to a first (i.e., the smallest) COUNT value that satisfies all of the following: 1) being greater than the value of RX_DELIV (the one prior to the update of RX_DELIV); 2) being greater than the LDC value being notified; and 3) a PDCP SDU associated with which has not been delivered to the upper layer yet and is still waited for. And then, if the current value of RX_DELIV is less than the current value of RX_NEXT, both values taken into account the possible update of the respective state variables, as described above, the receiving PDCP entity may further update its RX_REORD to be equal to the current value of RX_NEXT.

Under some circumstances, such as when congestion occurred in the RAN, the transmitting PDCP entity may need to suspend transmission to the receiving PDCP entity and hence discard the periodically generated PDU Sets contiguously (e.g., until the congestion is alleviated). However, each time when the transmitting PDCP entity discards a PDU Set for one traffic cycle, the transmitting PDCP entity may be unable to predict whether the next PDU Set for the next traffic cycle will be discarded or not, as the transmitting PDCP entity may be unable to predict whether the network congestion will be alleviated by then. Therefore, the transmitting PDCP entity may need to send, to the receiving PDCP entity, a PDCP Transmitting Status control PDU, as illustrated in FIGS. 4A-4C and described before, each time it discards a PDU Set that was targeted to the receiving PDCP entity, creating a multitude of signaling overhead. The example embodiments of the PDCP Transmitting Status control PDU being sent to notify about the discarded COUNT values with the FDC value and a bitmap, or with the FDC value and a number of additionally discarded contiguous COUNT values, or with the LDC value, as previously described and illustrated in FIGS. 4A-4C, respectively, can be sent just once when the transmission to the receiving PDCP entity is to be resumed, instead of sending it every time when discarding occurs. This may help to reduce signaling overhead, especially when the discarding happens repeatedly due to network congestion. However, the number of discarded PDCP PDUs due to network congestion may be quite large, e.g., could be at a rate of up to one thousand PDUs per second for a high resolution video typically used in an XR service, and hence requiring a large bitmap be carried in the bitmap field 408 or 2 to 3 octets for the Number of Additional Discarded COUNTs field, instead of 1 octet for the Number of Additional Discarded COUNTs field 428, as illustrated in FIG. 4B. Therefore, from signaling overhead point of view, notifying with the LDC value becomes advantageous in this situation.

According to various alternative embodiments, the transmitting PDCP entity may avoid notifying the receiving PDCP entity about the discarded COUNT values each time when the discarding occurs. Instead, the transmitting PDCP entity notifies the receiving PDCP entity about a COUNT value associated with and used on a PDCP PDU that is the first to be transmitted to the receiving PDCP entity when the transmission to the receiving PDCP entity is resumed (e.g., after the network congestion is alleviated), the COUNT being herein and hereafter referred to as the first resumed COUNT (FRC). Other ways for naming the FRC are also possible. One non-limiting example, the FRC may also be referred to as the First Transmitted COUNT or the Next COUNT, etc. By notifying the FRC, the transmitting PDCP entity may only need to send the notification once when the transmitting PDCP entity decides to resume the transmissions to the receiving PDCP entity, hence reducing the signaling overhead when the transmitting PDCP entity needs to discard the periodically generated PDU Sets contiguously, e.g., due to network congestion.

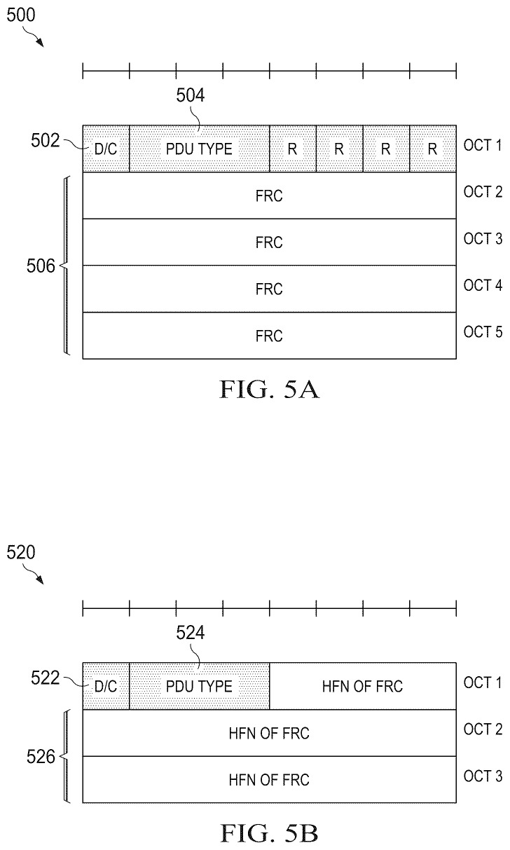

In accordance with one example embodiment, as illustrated in FIG. 5A, the transmitting PDCP entity sends, to the receiving PDCP entity, a PDCP control PDU referred to as the COUNT Update control PDU 500, the COUNT Update control PDU 500 including the D/C field 502, as described before, a PDU type field 504 carrying a value corresponding to the COUNT Update control PDU type, and an FRC field 506 carrying the FRC value.

When receiving the COUNT Update control PDU, the receiving PDCP entity may update its state variables such as RX_NEXT, RX_DELIV, and RX_REORD accordingly. For example, if the value in the FRC field 506 is greater than the value of RX_NEXT, the receiving PDCP entity updates RX_NEXT to be equal to the FRC value. Then, the receiving PDCP entity may further update its RX_DELIV. For example, the receiving PDCP entity updates its RX_DELIV to be equal to the FRC value (or the updated value of RX_NEXT). For another example, the receiving PDCP entity updates its RX_DELIV to be equal to a first (i.e., the smallest) COUNT value that satisfies all of the following: 1) being greater than the value of RX_DELIV (the one prior to the update of RX_DELIV); 2) being greater than or equal to the FRC value being notified; and 3) a PDCP SDU associated with which has not been delivered to the upper layer yet and is still waited for. And then, if the current value of RX_DELIV is less than the current value of RX_NEXT, both values taken into account the possible update of the respective state variables, as described above, the receiving PDCP entity may further update its RX_REORD to be equal to the current value of RX_NEXT.

In accordance with an alternative example embodiment, as illustrated in FIG. 5B, the transmitting PDCP entity sends, to the receiving PDCP entity, a PDCP control PDU referred to as the HFN Update control PDU 520, the HFN Update control PDU 520 including the D/C field 522, as described before, a PDU type field 524 carrying a value corresponding to the HFN Update control PDU type, and an HFN of FRC field 526 carrying the HFN portion of the COUNT (FRC) value of the PDCP PDU that is the first to be transmitted by the transmitting PDCP entity to the receiving PDCP entity, when transmissions to the receiving PDCP entity are resumed. The HFN of FRC field 526 is shown in FIG. 5B as a 20-bit field. This is for the case when the PDCP SN is configured to be 12 bits long. When the PDCP SN is configured to be 18 bits long, the HFN of FRC field in the HFN Update control PDU 520 can be 14 bits long, to maintain the total length of a full COUNT value at 32 bits. In that situation, the HFN Update control PDU 520 further includes 6 reserved bits.

When receiving the HFN Update control PDU 520, the receiving PDCP entity may store the value indicated in the HFN of FRC field 526. Then, when receiving a first PDCP PDU from the transmitting PDCP entity, the receiving PDCP entity may make a first attempt to reconstruct the COUNT value used on the first PDCP PDU, by concatenating the stored HFN value (as the MSBs of the COUNT) with the PDCP SN explicitly carried in the first PDCP PDU received (as the LSBs of the COUNT), and then use the reconstructed COUNT value to perform deciphering and integrity verification on the first PDCP PDU. If the deciphering and integrity verification are successful, the reconstructed COUNT value in the first attempt is considered as the correct one used on the first PDCP PDU. If either the deciphering or the integrity verification is unsuccessful, the receiving PDCP entity may make a second attempt to reconstruct the COUNT value used on the first PDCP PDU, by concatenating the sum of one and the stored HFN value (the sum being used as the MSBs of the COUNT) with the PDCP SN explicitly carried in the first PDCP PDU received (as the LSBs of the COUNT), and then use the reconstructed COUNT value in the second attempt to perform deciphering and integrity verification on the first PDCP PDU again. If the deciphering and integrity verification (in the second attempt) are successful, the reconstructed COUNT value in the second attempt is considered as the correct one used on the first PDCP PDU.

The reason that the first attempt may fail while the second attempt may succeed is that the PDCP PDU first successfully received by the receiving PDCP entity may be a PDCP PDU different than (and transmitted after) the PDCP PDU first transmitted by the transmitting PDCP entity when the transmission is resumed, due to possibly different numbers of hybrid automatic repeat request (HARQ) retransmissions and/or different numbers of RLC retransmissions being used in transmitting the first transmitted PDCP PDU and the first received PDCP PDU, respectively. In this situation, a first COUNT value used on the first received PDCP PDU should be greater than a second COUNT value used on the first transmitted PDCP PDU (the second COUNT value being the FRC), because the PDCP SDU carried by the first received PDCP PDU should have arrived at the transmitting PDCP entity (for a transmission) after the PDCP SDU carried by the first transmitted PDCP PDU did. It is possible that as the COUNT value increases from the second COUNT value to the first COUNT value, a wrap-around may have occurred in the PDCP SN portion, which causes the HFN portion to be incremented by one, meaning that the HFN value (which is not explicitly transmitted in PDCP data PDUs) of the first COUNT value is equal to the sum of one and the HFN value of the second COUNT value, the HFN value of the second COUNT value being the notified and stored HFN value. It is also possible that, in alternative implementations, the receiving PDP entity uses the sum of one and the stored HFN value (the sum being used as the MSBs of the reconstructed COUNT) in the first attempt and uses the stored HFN value (as the MSBs of the reconstructed COUNT) in the second attempt.

If a correctly reconstructed COUNT value is found in either attempt, the receiving PDCP entity may further update its state variables such as RX_NEXT accordingly. For example, if the correctly reconstructed COUNT value of the first PDCP PDU received is greater than or equal to the value of RX_NEXT, the receiving PDCP entity updates RX_NEXT to be equal to the sum of one and the correctly reconstructed COUNT value of the first PDCP PDU received. At this point, the receiving PDCP entity may be unable to determine whether the correctly reconstructed COUNT value on the first received PDCP PDU is the FRC or not, and hence unable to determine whether there is any COUNT value prior to the correctly reconstructed COUNT value that has been transmitted but hasn't been received yet and should be waited for. Therefore, in this situation, the receiving PDCP entity may update its RX_DELIV and RX_REORD in accordance with various example embodiments, as described in the following paragraphs.

In a first example embodiment, instead of immediately updating its RX_DELIV or RX_REORD after receiving the first PDCP PDU, the receiving PDCP entity first starts a timer with a specific initial value. The initial timer value may be set to cover the maximal amount of time required to finish the maximal number of HARQ retransmissions for the maximal number of RLC retransmissions for the maximal number of PDCP PDUs that can be transmitted in parallel from the transmitting PDCP entity to the receiving PDCP entity. When the timer expires, the receiving PDCP entity updates its RX_DELIV to be equal to a first (i.e., the smallest) COUNT value that satisfies both of the following: 1) being greater than the smallest COUNT value among the PDCP PDUs successfully received, deciphered, and integrity-verified since the transmission was resumed; and 2) a PDCP SDU associated with which has not been delivered to the upper layer yet and is still waited for. And then, if the current value of RX_DELIV is less than the current value of RX_NEXT, both values taken into account all the possible updates of the respective state variables since the transmission was resumed, the receiving PDCP entity may further update its RX_REORD to be equal to the current value of RX_NEXT.

In accordance with a second example embodiment, the receiving PDCP entity, after receiving the first PDCP PDU, initially updates its RX_DELIV to be equal to the sum of one and the correctly reconstructed COUNT value of the first PDCP PDU received and starts a timer with the specific initial value, as described before. Then, when a PDCP PDU is subsequently received, in addition to possibly updating its RX_NEXT as previously described, the receiving PDCP entity updates its RX_DELIV to be equal to the sum of one and a COUNT value used (i.e., correctly reconstructed) on the subsequently received PDCP PDU if all of the following are satisfied: 1) the timer is still running; 2) the COUNT value used on the subsequently received PDCP PDU is smaller than the value of RX_DELIV (the one prior to the update of RX_DELIV); and 3) a PDCP SDU associated with a COUNT value equal to the sum of one and the COUNT value on the subsequently received PDCP PDU has not been delivered to the upper layer yet and is still waited for. And then, if the current value of RX_DELIV is less than the current value of RX_NEXT, both values taken into account all the possible updates of the respective state variables since the transmission was resumed, the receiving PDCP entity may further update its RX_REORD to be equal to the current value of RX_NEXT.

In accordance with a third example embodiment, the receiving PDCP entity, after receiving the first PDCP PDU, initially updates its RX_DELIV to be equal to the sum of one and the correctly reconstructed COUNT value of the first PDCP PDU received. Then, when a PDCP PDU is subsequently received, in addition to possibly updating its RX_NEXT as previously described, the receiving PDCP entity updates its RX_DELIV to be equal to the sum of one and a COUNT value used (i.e., correctly reconstructed) on the subsequently received PDCP PDU if all of the following are satisfied: 1) the sum of a pre-specified number and the COUNT value used on the subsequently received PDCP PDU is greater than the COUNT value used on the first received PDCP PDU; 2) the COUNT value used on the subsequently received PDCP PDU is smaller than the value of RX_DELIV (the one prior to the update of RX_DELIV); and 3) a PDCP SDU associated with a COUNT value equal to the sum of one and the COUNT value on the subsequently received PDCP PDU has not been delivered to the upper layer yet and is still waited for. For example, the pre-specified number is the lesser one between the maximal number of PDCP PDUs that can be transmitted from the transmitting PDCP entity to the receiving PDCP entity simultaneously, using the maximal number of parallel HARQ processes allowed, and the maximal number of PDCP PDUs that can be produced by the video codec from a video frame. And then, if the current value of RX_DELIV is less than the current value of RX_NEXT, both values taken into account all possible updates of the respective state variables since the transmissions were resumed, the receiving PDCP entity may further update its RX_REORD to be equal to the current value of RX_NEXT.

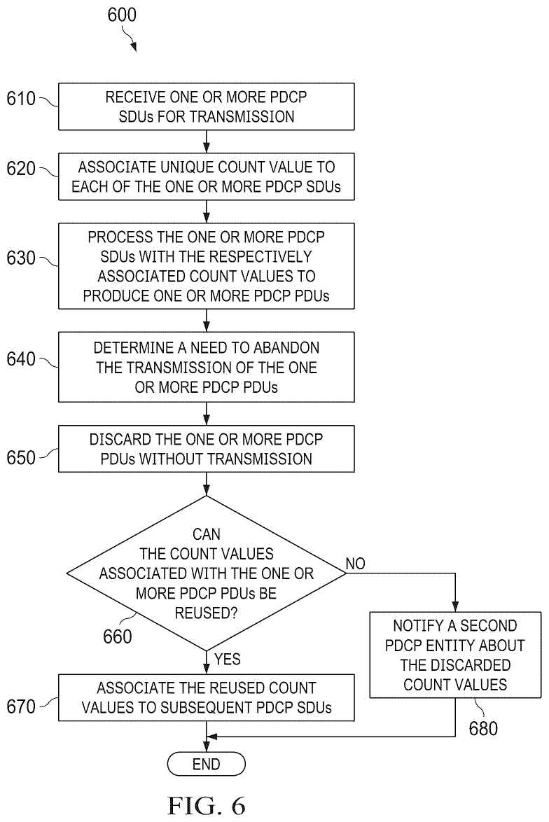

FIG. 6 illustrates a flow diagram of an example flow 600 occurring in a PDCP entity of a first device (e.g., the transmitting device). The flow 600 may be indicative of operations occurring in a PDCP entity of the first device, as the first device transmits data to a second device. The first device may be a UE and the second device may be a gNB, or vice versa, or the first and second devices may be peer UEs.

The flow 600 begins with the PDCP entity receiving one or more PDCP SDUs from its associated upper layer for transmission at the operation 610. Upon receiving each of the one or more PDCP SDUs, the PDCP entity may start a discard timer associated with the each of the one or more PDCP SDUs, respectively. The discard timer tracks a remaining time before a deadline for delivering the associated PDCP SDU and is stopped when the associated PDCP SDU is transmitted successful, and therefore is expired only when the deadline has passed without the associated PDCP SDU being transmitted successfully. The PDCP entity associates a unique COUNT value to each of the one or more PDCP SDUs at the operation 620. For example, a state variable (referred to as the TX_NEXT) of the PDCP entity is used for tracking the COUNT value to be associated to the next PDCP SDU received after a current PDCP SDU and is incremented by one after its current value is associated to the current PDCP SDU. The PDCP entity processes the each of the one or more PDCP SDUs with the respectively associated COUNT value to produce one or more PDCP PDUs, respectively, at the operation 630. For example, the processing includes performing integrity protection and ciphering for the each of the one or more PDCP SDUs by using the respectively associated COUNT value and adding a PDCP header to the integrity-protected and ciphered PDCP SDU to produce the associated PDCP PDU, the PDCP header including a PDCP SN, and the PDCP SN being a specified number of LSBs of the associated COUNT value.

Then, the PDCP entity determining a need to abandon the transmission of the one or more PDCP PDUs at the operation 640. For example, the PDCP entity may determine to abandon the transmission of the one or more PDCP PDUs in response to determining that a deadline for delivering the one or more PDCP PDUs has passed. For another example, the PDCP entity may determine to abandon the transmission of the one or more PDCP PDUs in response to determining that a congestion condition has occurred. For yet another example, the PDCP entity may determine to abandon the transmission of the one or more PDCP PDUs in response to determining that the one or more PDCP PDUs belong to a same PDU set and a discard timer associated with one of the one or more PDCP SDUs has expired. For yet another example, the PDCP entity may determine to abandon the transmission of the one or more PDCP PDUs in response to determining that the one or more PDCP PDUs belong to a first PDU set, the first PDU set being dependent upon a second PDU set preceding the first PDU set, and that the second PDU set was not successfully transmitted. The first PDU set is dependent on the second PDU set is a sense that receiving the first PDU set is useless for a recipient if the second PDU set has not been successfully received by the recipient. The PDCP entity discards the one or more PDCP PDUs without a transmission at the operation 650. For example, the PDCP entity discards any of the one or more PDCP PDUs that have not been submitted to its associated lower layer for the transmission without submitting them. For another example, the PDCP entity instructs its associated RLC entity to discard any of the one or more PDCP PDUs that have been submitting to the RLC entity for the transmission without transmitting them if the RLC entity has not transmitted them yet.

Then, the PDCP entity determines whether it can reuse the COUNT values associated with the one or more PDCP PDUs for subsequent PDCP SDUs at the operation 660. For example, if no PDCP SDUs have arrived at the PDCP entity for a transmission since the one or more PDCP SDUs arrived at the PDCP entity, then the COUNT values associated with the one or more PDCP PDUs can be reused for (i.e., be respectively associated to) the subsequent PDCP SDUs when they arrive. For another example, if the subsequent PDCP SDUs arrived immediately following the one or more PDCP SDUs have not been respectively associated with a unique COUNT value yet, then the COUNT values associated with the one or more PDCP PDUS can be reused for the subsequent PDCP SDUs. For yet another example, if the subsequent PDCP SDUs arrived immediately following the one or more PDCP SDUs have been respectively associated to a unique COUNT value and have been pre-processed with the respectively associated COUNT values, but the PDCP entity determines that there is sufficient time and computing resource to repeat the processing for the subsequent PDCP SDUs, then the COUNT values associated with the one or more PDCP PDUs can be reused for the subsequent PDCP SDUs, the repeating of the processing for the subsequent PDCP SDUs involving performing integrity protection and ciphering for the subsequent PDCP SDUs for a second time by using the reused COUNT values, respectively, to produce PDCP PDUs associated with the subsequent PDCP SDUs.

In response to determining that the COUNT values associated with the one or more PDCP PDUs can be reused for the subsequent PDCP SDUs, the PDCP entity associates the reused COUNT values to the subsequent PDCP SDUs and performs the processing for the subsequent PDCP SDUs using the associated COUNT values to produce the PDCP PDUs associated with the subsequent PDCP SDUs, respectively, at the operation 670. Then, the PDCP entity submits the produced PDCP PDUs to its associated lower layer for transmission, and the flow 600 may end.

On the other hand, in response to determining that the COUNT values associated with the one or more PDCP PDUs cannot be reused for the subsequent PDCP SDUs arrived immediately following the PDCP SDUs associated with the one or more PDCP PDUs in the operation 660, the PDCP entity sends a notification to a second PDCP entity of the second device (e.g. the receiving device) about the discarded COUNT values that are not to be reused, the second PDCP entity being a peer PDCP entity for receiving the data from the PDCP entity, at the operation 680. For example, the PDCP entity sends a PDCP Transmitting Status control PDU to the second PDCP entity, the PDCP Transmitting Status control PDU including an FDC field carrying the FDC value and a bitmap field carrying a bitmap indicating the discarding statuses of consecutive COUNT values that follow the FDC value, or the PDCP Transmitting Status control PDU including the FDC field carrying the FDC value and a Number of Additional Discarded COUNTs field carrying a value indicating the total number of additionally discarded COUNT values that are consecutively following the FDC value, or the PDCP Transmitting Status control PDU including an LDC field carrying the LDC value, wherein any COUNT values less than the LDC value and having not been received yet are to be considered as among the discarded COUNT values that are not to be reused, as described before. The PDCP entity determines the FDC value to be the smallest COUNT value among the discarded COUNT values. The PDCP entity determines the LDC value to be the largest COUNT value among the discarded COUNT values. The PDCP entity determines the size of the bitmap field or a value carried by the Number of Additional Discarded COUNTs field in accordance with a difference between the FDC and the LDC. Then, the flow 600 may end.

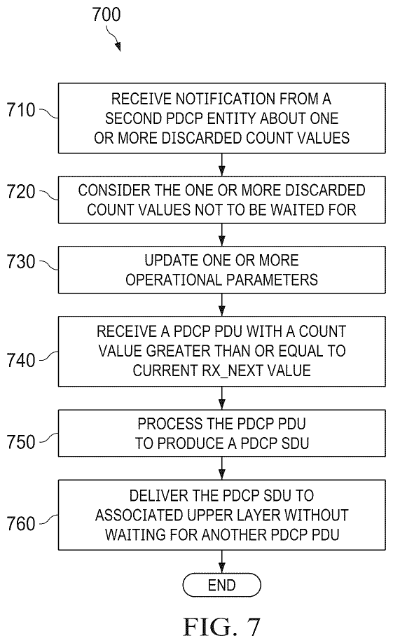

FIG. 7 illustrates a flow diagram of an example flow 700 occurring in a PDCP entity of a first device (e.g., the receiving device). The flow 700 may be indicative of operations occurring in a PDCP entity of a first device, as the first device receives data from a second device. The first device may be a UE and the second device may be a gNB, or vice versa, or the first and second devices may be peer UEs.

The method 700 begins with the PDCP entity receiving a notification from a second PDCP entity of the second device (e.g., the transmitting device) about one or more COUNT values that have been discarded and are not to be reused for transmitting another PDCP SDU at the operation 710, the second PDCP entity being a peer PDCP entity for transmitting the data to the PDCP entity. For example, the PDCP entity receives a PDCP Transmitting Status control PDU from the second PDCP entity, the PDCP Transmitting Status control PDU including an FDC field carrying the FDC value and a bitmap field carrying a bitmap indicating the discarding statuses of consecutive COUNT values that follow the FDC value, or the PDCP Transmitting Status control PDU including the FDC field carrying the FDC value and a Number of Additional Discarded COUNTs field carrying a value indicating the total number of additionally discarded COUNT values that are consecutively following the FDC value, or the PDCP Transmitting Status control PDU including an LDC field carrying the LDC value, wherein any COUNT values less than the LDC value and having not been received yet are considered as among the one or more COUNT values that have been discarded and are not to be reused, as described before. The PDCP entity considers the one or more COUNT values not to be waited for at the operation 720. The PDCP entity may further consider the one or more COUNT values as if having been received by the PDCP entity and having been delivered to its associated upper layer.

The PDCP entity updates one or more of its parameters associated with its operations for data reception at the operation 730. In one example embodiment, as the PDCP entity considers the one or more COUNT values as if having been received, the PDCP entity may update its state variables such as RX_NEXT, RX_DELIV, and/or RX_REORD, as previously described.

The PDCP entity receives a PDCP PDU associated with a reconstructed COUNT value that is greater than or equal to the current RX_NEXT value, taken into account the latest update of RX_NEXT, at the operation 740. The reconstructed COUNT value is reconstructed based on a PDCP SN included in the PDCP header of the received PDCP PDU and the current RX_DELIV value, taken into account the latest update of RX_DELIV. The PDCP entity processes the received PDCP PDU to produce a PDCP SDU at the operation 750. The processing includes using the reconstructed COUNT value to perform deciphering on a payload of the received PDCP PDU and to perform integrity verification on the deciphered payload. The processing may also include decompressing the upper layer headers in accordance with the configured header compression profiles. The PDCP entity delivers the produced PDCP SDU to its associated upper layer without waiting for another PDCP PDU associated with any of the one or more COUNT values being notified with at the operation 760. Then, the flow 700 may end.

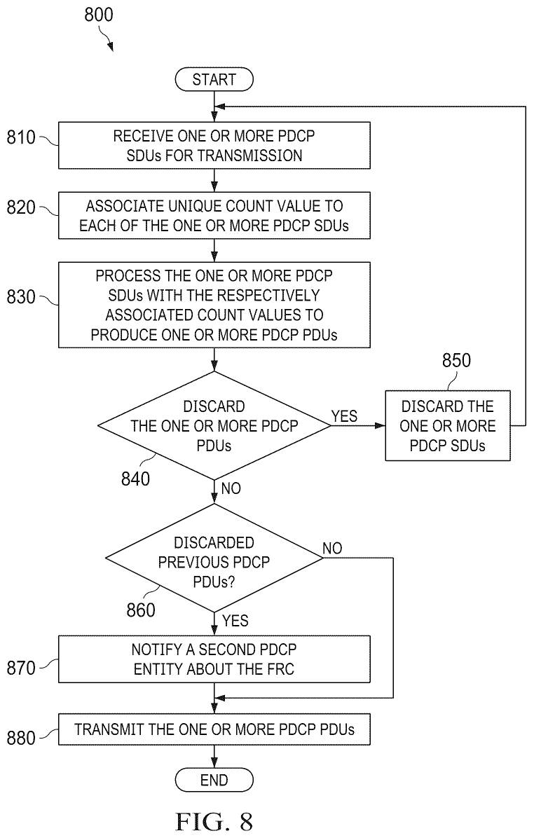

FIG. 8 illustrates a flow diagram of an alternative example flow 800 occurring in a PDCP entity of a first device (e.g., the transmitting device). The flow 800 may be indicative of operations occurring in a PDCP entity of a first device, as the first device transmits data to a second device. The first device may be a UE and the second device may be a gNB, or vice versa, or the first and second devices may be peer UEs.

The flow 800 begins with the PDCP entity receiving one or more PDCP SDUs from its associated upper layer for transmission at the operation 810. The PDCP entity associates a unique COUNT value to each of the one or more PDCP SDUs at the operation 820. The PDCP entity processes the each of the one or more PDCP SDUs with the respectively associated COUNT value to produce one or more PDCP PDUs, respectively, at the operation 830. Then, the PDCP entity determines whether there is a need to abandon the transmission of the one or more PDCP PDUs at the operation 840. If yes, the PDCP entity discards the one or more PDCP PDUs without a transmission at the operation 850. If not, the PDCP entity determines whether it has abandoned the transmission of PDCP PDU(s) during the previous traffic cycle at the operation 860. If not, the PDCP entity transmits the one or more PDCP PDUs at the operation 880. Then, the flow 800 may end. If yes, the PDCP entity sends a notification to a second PDCP entity of the second device, the notification including information about a first PDCP PDU, which is the first, among the one or more PDCP PDUs, to be transmitted to the second PDCP entity, the PDCP entity being a peer PDCP entity of the second PDCP entity for transmitting the data to the second PDCP entity at the operation 870. For example, the notification is sent in a PDCP control PDU. For example, the information about the first PDCP PDU comprises the COUNT value used by the PDCP entity in generating the first PDCP PDU. For an alternative example, the information about the first PDCP PDU comprises the HFN portion of the COUNT value used by the PDCP entity in generating the first PDCP PDU. Then, the PDCP entity transmits the one or more PDCP PDUs at the operation 880. Then, flow 800 may end.

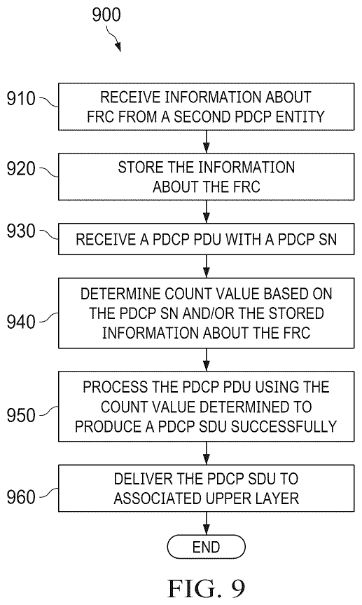

FIG. 9 illustrates a flow diagram of an example flow 900 occurring in a PDCP entity of a first device (e.g., the receiving device). The flow 900 may be indicative of operations occurring in a PDCP entity of a first device, as the first device receives data from a second device. The first device may be a UE and the second device may be a gNB, or vice versa, or the first and second devices may be peer UEs.

The flow 900 begins with the PDCP entity receiving a notification from a second PDCP entity of the second device, the notification including information about a first PDCP PDU to be transmitted to the PDCP entity, the second PDCP entity being a peer PDCP entity for transmitting the data to the PDCP entity at the operation 910. For example, the notification is received in a PDCP control PDU. For example, the information about the first PDCP PDU comprises a COUNT (which is the FRC) value used by the second PDCP entity in transmitting the first PDCP PDU to the PDCP entity. For an alternative example, the information about the first PDCP PDU comprises the HFN portion of a COUNT value, the COUNT (which is the FRC) value used by the second PDCP entity in transmitting the first PDCP PDU to the PDCP entity. The PDCP entity stores the information about the first PDCP PDU at the operation 920. For example, the information comprises the FRC value and the PDCP entity stores the information by updating its RX_NEXT and/or RX_DELIV to be equal to the FRC value, as previously described. For another example, the information comprises the HFN portion of the FRC value and the PDCP entity stores the information in its memory, as previously described. The PDCP entity receives a second PDCP PDU with a PDCP SN at the operation 930. The PDCP entity determines the COUNT value associated with the second PDCP PDU received, based on the PDCP SN received and/or the stored information about the first PDCP PDU at the operation 940. For example, the PDCP entity may determine the COUNT value associated with the second PDCP PDU by concatenating the stored the HFN portion of the FRC value or of the RX_DELIV value (the HFN portion being the MSBs of the COUNT value) with the PDCP SN received in the second PDCP PDU (the PDCP SN being the LSBs of the COUNT value). For another example, the PDCP entity may determine the COUNT value associated with the second PDCP PDU by concatenating the sum of one and the stored the HFN portion of the FRC value or of the RX_DELIV value (the sum being the MSBs of the COUNT value) with the PDCP SN received in the second PDCP PDU (the PDCP SN being the LSBs of the COUNT value). The PDCP entity successfully processes the second PDCP PDU, using the COUNT value determined, to produce a PDCP SDU at the operation 950. For example, the successful processing includes using the COUNT value to perform deciphering on a payload of the received PDCP PDU and to perform integrity verification on the deciphered payload successfully. The processing may also include decompressing the upper layer headers in accordance with the configured header compression profiles. The PDCP entity delivers the produced PDCP SDU to its associated upper layer at the operation 960. Then, the flow 900 may end.

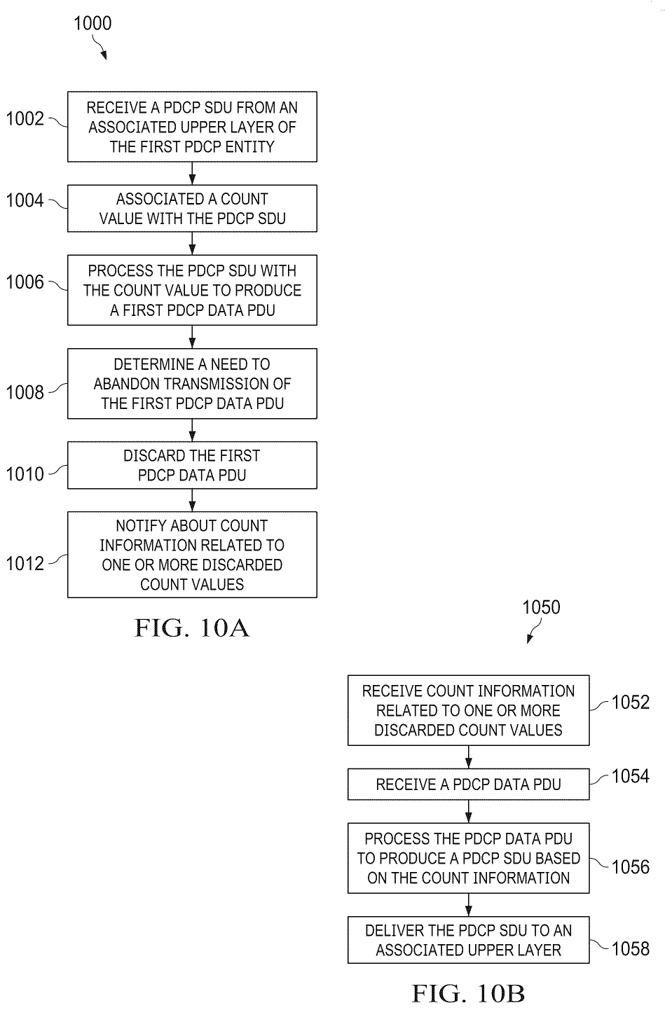

FIG. 10A illustrates a flow chart of a method 1000 performed by a first packet data convergence protocol (PDCP) entity of a first device, according to some embodiments. The first PDCP entity may include computer-readable code or instructions executing on one or more processors of the first device. Coding of the software for carrying out or performing the method 1000 is well within the scope of a person of ordinary skill in the art having regard to the present disclosure. The method 1000 may include additional or fewer operations than those shown and described and may be carried out or performed in a different order. Computer-readable code or instructions of the software executable by the one or more processors may be stored on a non-transitory computer-readable medium, such as for example, the memory of the first device.

The method 1000 starts at the operation 1002, where the first PDCP entity receives a PDCP service data unit (SDU) from an associated upper layer of the first PDCP entity. At the operation 1004, the first PDCP entity associates a COUNT value with the PDCP SDU. At the operation 1006, the first PDCP entity processes the PDCP SDU with the COUNT value to produce a first PDCP data protocol data unit (PDU). At the operation 1008, the first PDCP entity determines a need to abandon transmission of the first PDCP data PDU. At the operation 1010, the first PDCP entity discards the first PDCP data PDU based on the determining the need to abandon the transmission of the first PDCP data PDU. At the operation 1012, the first PDCP entity notifies a second PDCP entity of a second device about COUNT information related to one or more discarded COUNT values. The one or more discarded COUNT values are associated with one or more discarded PDCP data PDUs. The one or more discarded PDCP data PDUs include the first PDCP data PDU. The second PDCP entity is a peer PDCP entity of the first PDCP entity for processing data received from the first device.

In some embodiments, the COUNT information may indicate a first discarded COUNT (FDC) value. The FDC value may be a smallest COUNT value among the one or more discarded COUNT values.

In some embodiments, the COUNT information may further include a bitmap indicating additionally discarded COUNT values. The one or more discarded COUNT values may include the FDC value and the additionally discarded COUNT values. Each bit in the bitmap may correspond to a unique COUNT value among a sequence of contiguous COUNT values. The sequence of contiguous COUNT values may immediately follow the FDC value numerically and comprise the additionally discarded COUNT values. The each bit in the bitmap may carry either a first value indicating that a corresponding COUNT value is associated with a discarded PDCP data PDU or a second value indicating that the corresponding COUNT value is unassociated with any of the discarded PDCP data PDUs.

In some embodiments, the COUNT information may further indicate a total number of additionally discarded COUNT values. The one or more discarded COUNT values may include the FDC value and a number of contiguous COUNT values immediately following the FDC value numerically. The number may be equal to the total number.

In some embodiments, the COUNT information may indicate a last discarded COUNT (LDC) value. The LDC value may be a largest COUNT value among the one or more discarded COUNT values.

In some embodiments, the first PDCP entity may notify the second PDCP entity about the COUNT information by indicating that any COUNT values smaller than the LDC value and having not been received yet, upon being notified, are to be considered as among the one or more discarded COUNT values.

In some embodiments, the COUNT information may indicate a first resumed COUNT (FRC) value. The FRC value may be associated with a second PDCP data PDU. The second PDCP data PDU may be an earliest PDCP PDU to be transmitted to the second PDCP entity when the transmission to the second PDCP entity is resumed. The FRC value may be a smallest COUNT value used after the transmission to the second PDCP entity is resumed and greater than any of the one or more discarded COUNT values.

In some embodiments, the first PDCP entity may notify the second PDCP entity about the COUNT information by indicating that any COUNT values smaller than the FRC value and having not been received yet, upon being notified, are to be considered as among the one or more discarded COUNT values.

In some embodiments, the COUNT information may indicate a hyper frame number (HFN) value of a first resumed COUNT (FRC) value. The FRC value may be associated with a second PDCP data PDU. The second PDCP data PDU may be an earliest PDCP data PDU to be transmitted to the second PDCP entity when the transmission to the second PDCP entity is resumed. The FRC value may be a smallest COUNT value used after the transmission to the second PDCP entity is resumed and being greater than any of the one or more discarded COUNT values. The HFN value may be a value expressed by a pre-specified number of most significant bits of the FRC value.

In some embodiments, the first PDCP entity may notify the second PDCP entity about the COUNT information by sending to the second PDCP entity the COUNT information in a PDCP control PDU, in response to discarding the first PDCP data PDU.

In some embodiments, the first PDCP entity may determine, after discarding the first PDCP data PDU and before notifying the second PDCP entity, a need to resume transmission to the second PDCP entity.

In some embodiments, the first PDCP entity may notify the second PDCP entity about the COUNT information by sending to the second PDCP entity the COUNT information in a PDCP control PDU, in response to the determining the need to resume the transmission to the second PDCP entity.

In some embodiments, the COUNT information may further indicate that the one or more discarded COUNT values are not to be reused for processing another PDCP SDU for second transmission to the second PDCP entity.

In some embodiments, the first PDCP entity may determine that the one or more discarded COUNT values cannot be reused for processing another PDCP SDU before sending the COUNT information to the second PDCP entity.

In some embodiments, the first device may be a user equipment (UE), and the second device may be a base station. In some embodiments, the first device may be a base station, and the second device may be a UE. In some embodiments, the first device and the second device may be peer UEs.

In some embodiments, the first PDCP entity may process the PDCP SDU by performing integrity protection and ciphering for the PDCP SDU by using the COUNT value.

FIG. 10B illustrates a flow chart of a method 1050 performed by a first packet data convergence protocol (PDCP) entity of a first device, according to some embodiments. The first PDCP entity may include computer-readable code or instructions executing on one or more processors of the first device. Coding of the software for carrying out or performing the method 1050 is well within the scope of a person of ordinary skill in the art having regard to the present disclosure. The method 1050 may include additional or fewer operations than those shown and described and may be carried out or performed in a different order. Computer-readable code or instructions of the software executable by the one or more processors may be stored on a non-transitory computer-readable medium, such as for example, the memory of the first device.

The method 1050 starts at the operation 1052, where the first PDCP entity receives, from a second PDCP entity of a second device, COUNT information related to one or more discarded COUNT values. The one or more discarded COUNT values is respectively associated with one or more PDCP data protocol data units (PDUs) that have been discarded by the second PDCP entity. The second PDCP entity is a peer PDCP entity of the first PDCP entity for processing data for transmission to the first device. At the operation 1054, the first PDCP entity receives from the second PDCP entity a PDCP data PDU. At the operation 1056, the first PDCP entity processes the PDCP data PDU to produce a PDCP service data unit (SDU) based on the COUNT information. At the operation 1058, the first PDCP entity delivers the PDCP SDU to an associated upper layer without waiting for the one or more PDCP data PDUs associated with the one or more discarded COUNT values.

In some embodiments, the first PDCP entity may process the PDCP data PDU based on the COUNT information by determining a COUNT value associated with the PDCP data PDU using the COUNT information.

In some embodiments, the COUNT information may indicate a first discarded COUNT (FDC) value. The FDC value may be a smallest COUNT value among the one or more discarded COUNT values.

In some embodiments, the COUNT information may further include a bitmap indicating additionally discarded COUNT values. The one or more discarded COUNT values may include the FDC value and the additionally discarded COUNT values. Each bit in the bitmap may correspond to a unique COUNT value among a sequence of contiguous COUNT values. The sequence of contiguous COUNT values may immediately follow the FDC value numerically and comprise the additionally discarded COUNT values. The each bit in the bitmap may carry either a first value indicating that a corresponding COUNT value is associated with a corresponding discarded PDCP PDU or a second value indicating that the corresponding COUNT value is unassociated with any of the discarded PDCP PDUs.

In some embodiments, the first PDCP entity may determine a largest COUNT value among the one or more discarded COUNT values to be a COUNT value corresponding to a last bit set to the first value in the bitmap.

In some embodiments, the COUNT information may further indicate a total number of additionally discarded COUNT values. The one or more discarded COUNT values may include the FDC value and a number of contiguous COUNT values immediately following the FDC value numerically. The number may be equal to the total number indicated.

In some embodiments, the first PDCP entity may determine a largest COUNT value among the one or more discarded COUNT values to be equal to a sum of the FDC value and the total number indicated by the COUNT information.

In some embodiments, the COUNT information may indicate a last discard COUNT (LDC) value, the LDC value being a largest COUNT value among the one or more discarded COUNT values.

In some embodiments, the first PDCP entity may update a state variable RX_NEXT of the first PDCP entity to be equal to a sum of one and the largest COUNT value among the one or more discarded COUNT values in response to determining that the sum is greater than an RX_NEXT value prior to the updating.

In some embodiments, the first PDCP entity may update a state variable RX_DELIV of the first PDCP entity to be equal to a sum of one and the largest COUNT value among the one or more discarded COUNT values.

In some embodiments, the first PDCP entity may update a state variable RX_DELIV of the first PDCP entity to be equal to a smallest COUNT value satisfying all of being greater than an RX_DELIV value prior to the updating, being greater than or equal to a sum of one and the largest COUNT value among the one or more discarded COUNT values, and a PDCP SDU associated with which has not been delivered to upper layer associated with the first PDCP entity yet and is still waited for.

In some embodiments, the first PDCP entity may determine COUNT values that are smaller than the LDC value and have not been received yet as being among the one or more discarded COUNT values.

In some embodiments, the COUNT information may indicate a first resumed COUNT (FRC) value. The FRC value may be associated with a second PDCP data PDU. The second PDCP data PDU may be an earliest PDCP data PDU to be transmitted by the second PDCP entity upon being notified, and the FRC value being a smallest COUNT value to be used in transmitting a next PDCP data PDU by the second PDCP entity upon notifying the first PDCP entity.

In some embodiments, the first PDCP entity may update a state variable RX_NEXT of the first PDCP entity to be equal to the FRC value indicated by the COUNT information in response to determining that the FRC value is greater than an RX_NEXT value prior to the updating.

In some embodiments, the first PDCP entity may update a state variable RX_DELIV of the first PDCP entity to be equal to the FRC value indicated by the COUNT information.

In some embodiments, the first PDCP entity may update a state variable RX_DELIV of the first PDCP entity to be equal to a smallest COUNT value satisfying all of being greater than an RX_DELIV value prior to the updating, being greater than or equal to the FRC value being notified, and a PDCP SDU associated with which has not been delivered to upper layer associated with the first PDCP entity yet and is still waited for.

In some embodiments, the first PDCP entity may determine COUNT values that are smaller than the FRC value and have not been received yet as being among the one or more discarded COUNT values.

In some embodiments, the COUNT information may indicate a hyper frame number (HFN) value of a first resumed COUNT (FRC) value. The FRC value may be associated with a second PDCP data PDU. The second PDCP data PDU may be an earliest PDCP data PDU to be transmitted from the second PDCP entity upon being notified. The FRC value may be a smallest COUNT value to be used in transmitting a next PDCP data PDU by the second PDCP entity upon notifying the first PDCP entity.

In some embodiments, the first PDCP entity may receive the COUNT information by receiving the COUNT information in a PDCP control PDU.

In some embodiments, the first PDCP entity may determine that the one or more PDCP PDUs associated with the one or more discarded COUNT values are not to be waited for.

In some embodiments, the first PDCP entity may consider that the one or more PDCP PDUs associated with the one or more discarded COUNT values as if having been received and delivered to upper layer associated with the first PDCP entity.

In some embodiments, the first device may be a user equipment (UE), and the second device may be a base station. In some embodiments, the first device may be a base station, and the second device may be a UE. In some embodiments, the first device and the second device may be peer UEs.

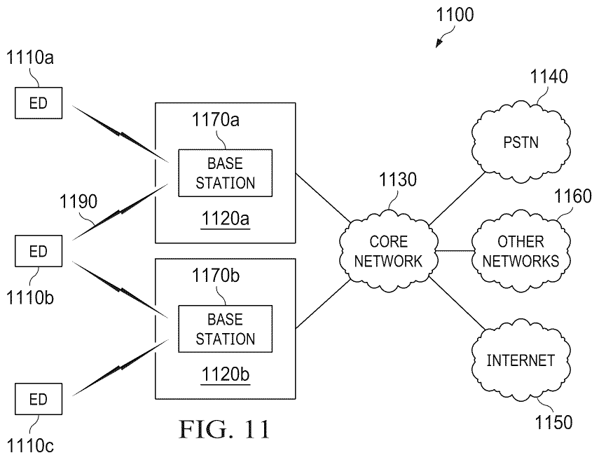

FIG. 11 illustrates an example communication system 1100. In general, the system 1100 enables multiple wireless or wired users to transmit and receive data and other content. The system 1100 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1100 includes electronic devices (ED) 1110a-1110c, radio access networks (RANs) 1120a-1120b, a core network 1130, a public switched telephone network (PSTN) 1140, the Internet 1150, and other networks 1160. While certain numbers of these components or elements are shown in FIG. 11, any number of these components or elements may be included in the system 1100.

The EDs 1110a-1110c are configured to operate or communicate in the system 1100. For example, the EDs 1110a-1110c are configured to transmit or receive via wireless or wired communication channels. Each ED 1110a-1110c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1120a-1120b here include base stations 1170a-1170b, respectively. Each base station 1170a-1170b is configured to wirelessly interface with one or more of the EDs 1110a-1110c to enable access to the core network 1130, the PSTN 1140, the Internet 1150, or the other networks 1160. For example, the base stations 1170a-1170b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1110a-1110c are configured to interface and communicate with the Internet 1150 and may access the core network 1130, the PSTN 1140, or the other networks 1160.

In the embodiment shown in FIG. 11, the base station 1170a forms part of the RAN 1120a, which may include other base stations, elements, or devices. Also, the base station 1170b forms part of the RAN 1120b, which may include other base stations, elements, or devices. Each base station 1170a-1170b operates to transmit or receive wireless signals within a particular geographic region or area, sometimes referred to as a “cell.” In some embodiments, multiple-input multiple-output (MIMO) technology may be employed having multiple transceivers for each cell.

The base stations 1170a-1170b communicate with one or more of the EDs 1110a-1110c over one or more air interfaces 1190 using wireless communication links. The air interfaces 1190 may utilize any suitable radio access technology.

It is contemplated that the system 1100 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1120a-1120b are in communication with the core network 1130 to provide the EDs 1110a-1110c with voice, data, application, Voice over Internet Protocol (VOIP), or other services. Understandably, the RANs 1120a-1120b or the core network 1130 may be in direct or indirect communication with one or more other RANs (not shown). The core network 1130 may also serve as a gateway access for other networks (such as the PSTN 1140, the Internet 1150, and the other networks 1160). In addition, some or all of the EDs 1110a-1110c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1150.

Although FIG. 11 illustrates one example of a communication system, various changes may be made to FIG. 11. For example, the communication system 1100 could include any number of EDs, base stations, networks, or other components in any suitable configuration.

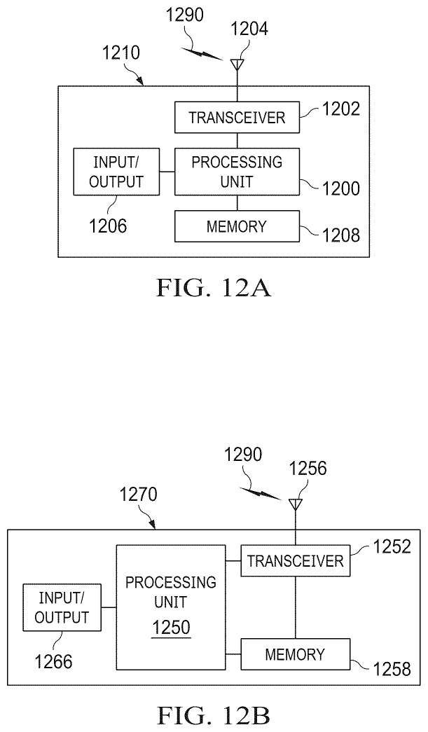

FIGS. 12A and 12B illustrate example devices that may implement the methods and teachings according to this disclosure. In particular, FIG. 12A illustrates an example ED 1210, and FIG. 12B illustrates an example base station 1270. These components could be used in the system 1100 or in any other suitable system.

As shown in FIG. 12A, the ED 1210 includes at least one processing unit 1200. The processing unit 1200 implements various processing operations of the ED 1210. For example, the processing unit 1200 could perform signal coding, data processing, power control, input/output processing, or any other functionality enabling the ED 1210 to operate in the system 1100. The processing unit 1200 also supports the methods and teachings described in more detail above. Each processing unit 1200 includes any suitable processing or computing device configured to perform one or more operations. Each processing unit 1200 could, for example, include a microprocessor, microcontroller, digital signal processor, field programmable gate array, or application specific integrated circuit.

The ED 1210 also includes at least one transceiver 1202. The transceiver 1202 is configured to modulate data or other content for transmission by at least one antenna or NIC (Network Interface Controller) 1204. The transceiver 1202 is also configured to demodulate data or other content received by the at least one antenna 1204. Each transceiver 1202 includes any suitable structure for generating signals for wireless or wired transmission or processing signals received wirelessly or by wire. Each antenna 1204 includes any suitable structure for transmitting or receiving wireless or wired signals. One or multiple transceivers 1202 could be used in the ED 1210, and one or multiple antennas 1204 could be used in the ED 1210. Although shown as a single functional unit, a transceiver 1202 could also be implemented using at least one transmitter and at least one separate receiver.

The ED 1210 further includes one or more input/output devices 1206 or interfaces (such as a wired interface to the Internet 1150). The input/output devices 1206 facilitate interaction with a user or other devices (network communications) in the network. Each input/output device 1206 includes any suitable structure for providing information to or receiving information from a user, such as a speaker, microphone, keypad, keyboard, display, or touch screen, including network interface communications.

In addition, the ED 1210 includes at least one memory 1208. The memory 1208 stores instructions and data used, generated, or collected by the ED 1210. For example, the memory 1208 could store software or firmware instructions executed by the processing unit(s) 1200 and data used to reduce or eliminate interference in incoming signals. Each memory 1208 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 12B, the base station 1270 includes at least one processing unit 1250, at least one transceiver 1252, which includes functionality for a transmitter and a receiver, one or more antennas 1256, at least one memory 1258, and one or more input/output devices or interfaces 1266. A scheduler, which would be understood by one skilled in the art, is coupled to the processing unit 1250. The scheduler could be included within or operated separately from the base station 1270. The processing unit 1250 implements various processing operations of the base station 1270, such as signal coding, data processing, power control, input/output processing, or any other functionality. The processing unit 1250 can also support the methods and teachings described in more detail above. Each processing unit 1250 includes any suitable processing or computing device configured to perform one or more operations. Each processing unit 1250 could, for example, include a microprocessor, microcontroller, digital signal processor, field programmable gate array, or application specific integrated circuit.

Each transceiver 1252 includes any suitable structure for generating signals for wireless or wired transmission to one or more EDs or other devices. Each transceiver 1252 further includes any suitable structure for processing signals received wirelessly or by wire from one or more EDs or other devices. Although shown combined as a transceiver 1252, a transmitter and a receiver could be separate components. Each antenna 1256 includes any suitable structure for transmitting or receiving wireless or wired signals. While a common antenna 1256 is shown here as being coupled to the transceiver 1252, one or more antennas 1256 could be coupled to the transceiver(s) 1252, allowing separate antennas 1256 to be coupled to the transmitter and the receiver if equipped as separate components. Each memory 1258 includes any suitable volatile or non-volatile storage and retrieval device(s). Each input/output device 1266 facilitates interaction with a user or other devices (network communications) in the network. Each input/output device 1266 includes any suitable structure for providing information to or receiving/providing information from a user, including network interface communications.

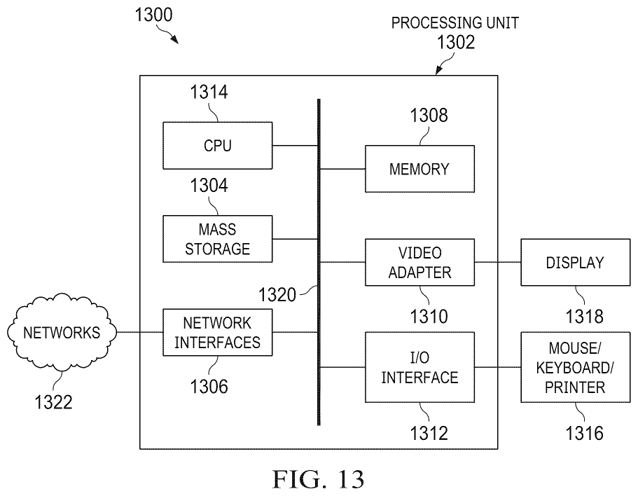

FIG. 13 is a block diagram of a computing system 1300 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1300 includes a processing unit 1302. The processing unit includes a central processing unit (CPU) 1314, memory 1308, and may further include a mass storage device 1304, a video adapter 1310, and an I/O interface 1312 connected to a bus 1320.

The bus 1320 may be one or more of any type of several bus architectures including a memory bus or memory controller, a peripheral bus, or a video bus. The CPU 1314 may comprise any type of electronic data processor. The memory 1308 may comprise any type of non-transitory system memory such as static random access memory (SRAM), dynamic random access memory (DRAM), synchronous DRAM (SDRAM), read-only memory (ROM), or a combination thereof. In an embodiment, the memory 1308 may include ROM for use at boot-up, and DRAM for program and data storage for use while executing programs.

The mass storage 1304 may comprise any type of non-transitory storage device configured to store data, programs, and other information and to make the data, programs, and other information accessible via the bus 1320. The mass storage 1304 may comprise, for example, one or more of a solid state drive, hard disk drive, a magnetic disk drive, or an optical disk drive.

The video adapter 1310 and the I/O interface 1312 provide interfaces to couple external input and output devices to the processing unit 1302. As illustrated, examples of input and output devices include a display 1318 coupled to the video adapter 1310 and a mouse, keyboard, or printer 1316 coupled to the I/O interface 1312. Other devices may be coupled to the processing unit 1302, and additional or fewer interface cards may be utilized. For example, a serial interface such as Universal Serial Bus (USB) (not shown) may be used to provide an interface for an external device.

The processing unit 1302 also includes one or more network interfaces 1306, which may comprise wired links, such as an Ethernet cable, or wireless links to access nodes or different networks. The network interfaces 1306 allow the processing unit 1302 to communicate with remote units via the networks. For example, the network interfaces 1306 may provide wireless communication via one or more transmitters/transmit antennas and one or more receivers/receive antennas. In an embodiment, the processing unit 1302 is coupled to a local-area network 1322 or a wide-area network for data processing and communications with remote devices, such as other processing units, the Internet, or remote storage facilities.

It should be appreciated that one or more steps of the embodiment methods provided herein may be performed by corresponding units or modules. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method, comprising:
receiving, by a first packet data convergence protocol (PDCP) entity of a first device, a PDCP service data unit (SDU) from an associated upper layer of the first PDCP entity;
associating, by the first PDCP entity, a COUNT value with the PDCP SDU;
processing, by the first PDCP entity, the PDCP SDU with the COUNT value to produce a first PDCP data protocol data unit (PDU);
determining, by the first PDCP entity, a need to abandon transmission of the first PDCP data PDU;
discarding, by the first PDCP entity, the first PDCP data PDU based on the determining; and
notifying, by the first PDCP entity, a second PDCP entity of a second device about COUNT information related to one or more discarded COUNT values, the one or more discarded COUNT values being associated with one or more discarded PDCP data PDUs, the one or more discarded PDCP data PDUs including the first PDCP data PDU, the second PDCP entity being a peer PDCP entity of the first PDCP entity for processing data received from the first device.

2. The method of claim 1, the notifying the second PDCP entity of the second device comprising:
sending, by the first PDCP entity to the second PDCP entity, the COUNT information in a PDCP control PDU.

3. The method of claim 2, the COUNT information indicating a first discarded COUNT (FDC) value, the FDC value being a smallest COUNT value among the one or more discarded COUNT values.

4. The method of claim 3, the COUNT information further including a bitmap indicating additionally discarded COUNT values, the one or more discarded COUNT values including the FDC value and the additionally discarded COUNT values, each bit in the bitmap corresponding to a unique COUNT value among a sequence of contiguous COUNT values, the sequence of contiguous COUNT values immediately following the FDC value numerically and comprising the additionally discarded COUNT values, the each bit in the bitmap carrying either a first value indicating that a corresponding COUNT value is associated with a discarded PDCP data PDU or a second value indicating that the corresponding COUNT value is unassociated with any of the discarded PDCP data PDUs.

5. The method of claim 3, the COUNT information further indicating a total number of additionally discarded COUNT values, the one or more discarded COUNT values including the FDC value and a number of contiguous COUNT values immediately following the FDC value numerically, the number being equal to the total number.

6. The method of claim 2, the COUNT information indicating a last discarded COUNT (LDC) value and that any COUNT values smaller than the LDC value and having not been received yet, upon being notified, are to be considered as among the one or more discarded COUNT values, the LDC value being a largest COUNT value among the one or more discarded COUNT values.

7. The method of claim 2, the COUNT information indicating a first resumed COUNT (FRC) value and that any COUNT values smaller than the FRC value and having not been received yet, upon being notified, are to be considered as among the one or more discarded COUNT values, the FRC value being associated with a second PDCP data PDU, the second PDCP data PDU being an earliest PDCP PDU to be transmitted to the second PDCP entity when the transmission to the second PDCP entity is resumed, and the FRC value being a smallest COUNT value used after the transmission to the second PDCP entity is resumed and being greater than any of the one or more discarded COUNT values.

8. The method of claim 2, the COUNT information indicating a hyper frame number (HFN) value of a first resumed COUNT (FRC) value, the FRC value being associated with a second PDCP data PDU, the second PDCP data PDU being an earliest PDCP data PDU to be transmitted to the second PDCP entity when the transmission to the second PDCP entity is resumed, and the FRC value being a smallest COUNT value used after the transmission to the second PDCP entity is resumed and being greater than any of the one or more discarded COUNT values, and the HFN value being a value expressed by a pre-specified number of most significant bits of the FRC value.

9. The method of claim 1, the first device being one of a user equipment (UE) or a base station, and the second device being the other of the UE or the base station.

10. The method of claim 1, the first device and the second device being peer UEs.

11. A method, comprising:
receiving, by a first packet data convergence protocol (PDCP) entity of a first device from a second PDCP entity of a second device, COUNT information related to one or more discarded COUNT values, the one or more discarded COUNT values respectively associated with one or more PDCP data protocol data units (PDUs) that have been discarded by the second PDCP entity, the second PDCP entity being a peer PDCP entity of the first PDCP entity for processing data for transmission to the first device;
receiving, by the first PDCP entity from the second PDCP entity, a PDCP data PDU;
processing, by the first PDCP entity, the PDCP data PDU to produce a PDCP service data unit (SDU) based on the COUNT information; and
delivering, by the first PDCP entity, the PDCP SDU to an associated upper layer.

12. The method of claim 11, the COUNT information being received in a PDCP control PDU.

13. The method of claim 12, the COUNT information indicating a first discarded COUNT (FDC) value, the FDC value being a smallest COUNT value among the one or more discarded COUNT values.

14. The method of claim 13, the COUNT information further including a bitmap indicating additionally discarded COUNT values, the one or more discarded COUNT values including the FDC value and the additionally discarded COUNT values, each bit in the bitmap corresponding to a unique COUNT value among a sequence of contiguous COUNT values, the sequence of contiguous COUNT values immediately following the FDC value numerically and comprising the additionally discarded COUNT values, the each bit in the bitmap carrying either a first value indicating that a corresponding COUNT value is associated with a corresponding discarded PDCP PDU or a second value indicating that the corresponding COUNT value is unassociated with any of the discarded PDCP PDUs.

15. The method of claim 14, further comprising:
updating, by the first PDCP entity, a state variable RX_NEXT of the first PDCP entity to be equal to a sum of one and the largest COUNT value among the one or more discarded COUNT values in response to determining that the sum is greater than an RX_NEXT value prior to the updating.

16. The method of claim 14, further comprising:
updating, by the first PDCP entity, a state variable RX_DELIV of the first PDCP entity to be equal to a sum of one and the largest COUNT value among the one or more discarded COUNT values.

17. The method of claim 14, further comprising:
updating, by the first PDCP entity, a state variable RX_DELIV of the first PDCP entity to be equal to a smallest COUNT value satisfying all of being greater than an RX_DELIV value prior to the updating, being greater than or equal to a sum of one and the largest COUNT value among the one or more discarded COUNT values, and a PDCP SDU associated with which has not been delivered to upper layer associated with the first PDCP entity yet and is still waited for.

18. The method of claim 13, the COUNT information further indicating a total number of additionally discarded COUNT values, the one or more discarded COUNT values including the FDC value and a number of contiguous COUNT values immediately following the FDC value numerically, the number being equal to the total number indicated, the method further comprising:
determining, by the first PDCP entity, a largest COUNT value among the one or more discarded COUNT values to be equal to a sum of the FDC value and the total number indicated by the COUNT information.

19. The method of claim 12, the COUNT information indicating a last discard COUNT (LDC) value, the LDC value being a largest COUNT value among the one or more discarded COUNT values.

20. The method of claim 12, the COUNT information indicating a first resumed COUNT (FRC) value, the FRC value being associated with a second PDCP data PDU, the second PDCP data PDU being an earliest PDCP data PDU to be transmitted by the second PDCP entity upon being notified, and the FRC value being a smallest COUNT value to be used in transmitting a next PDCP data PDU by the second PDCP entity upon notifying the first PDCP entity, the method further comprising:
updating, by the first PDCP entity, a state variable RX_NEXT of the first PDCP entity to be equal to the FRC value indicated by the COUNT information in response to determining that the FRC value is greater than an RX_NEXT value prior to the updating.

21. The method of claim 12, the COUNT information indicating a hyper frame number (HFN) value of a first resumed COUNT (FRC) value, the FRC value being associated with a second PDCP data PDU, the second PDCP data PDU being an earliest PDCP data PDU to be transmitted from the second PDCP entity upon being notified, and the FRC value being a smallest COUNT value to be used in transmitting a next PDCP data PDU by the second PDCP entity upon notifying the first PDCP entity.

22. The method of claim 11, further comprising:
determining, by the first PDCP entity, that the one or more PDCP PDUs associated with the one or more discarded COUNT values are discarded.

23. The method of claim 11, further comprising:
considering, by the first PDCP entity, the one or more PDCP PDUs associated with the one or more discarded COUNT values as if having been received and delivered to upper layer associated with the first PDCP entity.

24. The method of claim 11, the first device being one of a user equipment (UE) or a base station, and the second device being the other of the UE or the base station.

25. The method of claim 11, the first device and the second device being peer UEs.

26. A first device comprising:
at least one processor; and
a non-transitory computer readable storage medium storing instructions that, when executed by the at least one processor, cause a first packet data convergence protocol (PDCP) entity of the first device to perform operations including:
receiving a PDCP service data unit (SDU) from an associated upper layer of the first PDCP entity;
associating a COUNT value with the PDCP SDU;
processing the PDCP SDU with the COUNT value to produce a first PDCP data protocol data unit (PDU);
determining a need to abandon transmission of the first PDCP data PDU;
discarding the first PDCP data PDU based on the determining; and
notifying a second PDCP entity of a second device about COUNT information related to one or more discarded COUNT values, the one or more discarded COUNT values being associated with one or more discarded PDCP data PDUs, the one or more discarded PDCP data PDUs including the first PDCP data PDU, the second PDCP entity being a peer PDCP entity of the first PDCP entity for processing data received from the first device.

27. A first device comprising:
at least one processor; and
a non-transitory computer readable storage medium storing instructions that, when executed by the at least one processor, cause a first packet data convergence protocol (PDCP) entity of the first device to perform operations including:
receiving, from a second PDCP entity of a second device, COUNT information related to one or more discarded COUNT values, the one or more discarded COUNT values respectively associated with one or more PDCP data protocol data units (PDUs) that have been discarded by the second PDCP entity, the second PDCP entity being a peer PDCP entity of the first PDCP entity for processing data for transmission to the first device;
receiving, from the second PDCP entity, a PDCP data PDU;
processing the PDCP data PDU to produce a PDCP service data unit (SDU) based on the COUNT information; and
delivering the PDCP SDU to an associated upper layer without waiting for the one or more PDCP data PDUs associated with the one or more discarded COUNT values.
